(19) United States
(12) Patent Application Publication
(10) Pub. No.: US 2026/0020003 A1
(43) Pub. Date: Jan. 15, 2026

(54) LOW-RESOLUTION BEHAVIOR IN A RADIO NODE

(71) Applicant: Lenovo (Singapore) Pte Ltd, Singapore (SG)

(72) Inventors: Seyedomid Taghizadeh Motlagh, Oberursel (DE); Karthikeyan Ganesan, Kronberg Im Taunus (DE); Colin Frank, Park Ridge, IL (US); Ali Ramadan Ali, Kraiburg (DE)

(73) Assignee: Lenovo (Singapore) Pte Ltd, Singapore (SG)

(21) Appl. No.: 18/769,232

(22) Filed: Jul. 10, 2024

(51) Int. Cl. H04W 72/0446; H04L 5/00

(52) U.S. Cl. CPC H04W 72/0446; H04L 5/005

(57) ABSTRACT

Various aspects of the present disclosure relate to low-resolution behavior in a radio node. An apparatus, such as a user equipment (UE) and/or a network equipment (NE), transmits first capability information comprising one or more low-resolution transmit behaviors of the first radio node, receives second configuration information for transmission of a reference signal, and transmits, based at least in part on the second configuration information, one or more reference signals.

### TECHNICAL FIELD

The present disclosure relates to wireless communications, and more specifically to power conservation in wireless communications systems.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system may support wireless communications, and may include one or more devices, such as UEs, base stations (e.g., gNBs), network entities, satellites, and/or network equipment (NE), among other devices, that transmit and/or receive signaling.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may include a UE for wireless communication transmit first capability information including one or more low-resolution transmit behaviors of the UE; receive second configuration information for transmission of a RS; and transmit, based at least in part on the second configuration information, one or more RSs.

In some implementations of the method and apparatuses for a UE described herein, the one or more low-resolution transmit behaviors of the UE are associated with a low resolution digital-to-analog converter (DAC) of the UE, and the RS includes a sequence of time-domain complex values; the first capability information includes capability information for the UE, the capability information including one or more of: a discrete set as a subset of one or more supported steps of one or more DACs of the UE; a first value equal to or smaller than a number of quantization states supported by the one or more DACs of the UE; a second value equal to or smaller than a number of quantization bits supported by the one or more DACs of the UE; or at least one supported sampling time of the one or more DACs of the UE; the second configuration information includes one or more of: a sequence of complex values defined in time-domain as an output of a digital baseband processor; a defined sequence of complex values defined in the time-domain as input of one or more DACs of the UE; one or more of a sampling time or a sampling rate associated with the defined sequence of complex values; a scaling value applied on the defined sequence of complex values; a phase rotation applied on the define complex sequence of complex values; a reference to one or more previous RSs; or different RS definitions for multiple different transmission directions.

In some implementations of the method and apparatuses for a UE described herein, the at least one processor is configured to cause the UE to autonomously determine one or more RS parameters; the at least one processor is configured to cause the UE to one or more of: time division multiplex (TDM) the one or more RSs with a second transmission; assign the one or more RSs to one or more indicated symbols; or assign the one or more RSs to one or more dedicated symbols within a slot, the one or more dedicated symbols including symbol features dedicated for RSs; a slot or a subframe that includes one or more RS symbols includes differing parameters or characteristics than a slot or a subframe that does not include one or more RS symbols; one or more of: one or more of RS symbol parameters, RS symbol slot format, or RS subframe format are indicated via reference to a codebook; or a codebook for RS is associated with one or more of a transmission direction or a low resolution feature of the UE; one or more of: the one or more RSs are time division multiplexed (TDM) as part of a defined symbol; or the one or more RSs are TDM within a shared symbol with a second transmission; one or more of: transmission of the one or more RSs at a symbol including an inverse Fast Fourier Transform (IFFT) stage includes shaping dedicated resource elements (REs) for time-domain shaping; or transmission of the one or more RSs at a symbol including an IFFT stage includes adjusting an IFFT length to a RS duration and multiplexing the one or more RSs at a post-IFFT stage; the one or more RSs are TDM within a symbol with modulated RS samples at time-samples corresponding to a cyclic prefix (CP) of an associated signal at a pre-CP insertion stage.

In some implementations of the method and apparatuses for a UE described herein, the at least one processor is configured to cause the UE to generate the one or more RSs using a digital quantization step from one or more supported digital quantization steps of the UE; the at least one processor is configured to cause the UE to generate the one or more RSs using digital quantization at one or more of: after an IFFT stage and prior to CP insertion; after the IFFT stage and after CP insertion; after an upsampling and filtering stage; or after a RS generated in time domain; the at least one processor is configured to cause the UE to adjust one or more parameters of the one or more RSs to be within a discrete space prior to transmission of the one or more RSs; the at least one processor is configured to cause the UE to transmit an indication of the adjusted one or more parameters of the one or more RSs.

Some implementations of the method and apparatuses described herein may further include a processor for wireless communication to transmit first capability information including one or more low-resolution transmit behaviors of a radio node; receive second configuration information for transmission of a RS; and transmit, based at least in part on the second configuration information, one or more RSs.

Some implementations of the method and apparatuses described herein may further include a method performed by a UE, the method including transmitting first capability information including one or more low-resolution transmit behaviors of the UE; receiving second configuration information for transmission of a RS; and transmitting, based at least in part on the second configuration information, one or more RSs.

In some implementations of the method and apparatuses for a UE described herein, the one or more low-resolution transmit behaviors of the UE are associated with a low resolution DAC of the UE, and the RS includes a sequence of time-domain complex values; the first capability information includes capability information for the UE, the capability information including one or more of: a discrete set as a subset of one or more supported steps of one or more DACs of the UE; a first value equal to or smaller than a number of quantization states supported by the one or more DACs of the UE; a second value equal to or smaller than a number of quantization bits supported by the one or more DACs of the UE; or at least one supported sampling time of the one or more DACs of the UE; the second configuration information includes one or more of: a sequence of complex values defined in time-domain as an output of a digital baseband processor; a defined sequence of complex values defined in the time-domain as input of one or more DACs of the UE; one or more of a sampling time or a sampling rate associated with the defined sequence of complex values; a scaling value applied on the defined sequence of complex values; a phase rotation applied on the define complex sequence of complex values; a reference to one or more previous RSs; or different RS definitions for multiple different transmission directions; autonomously determining one or more RS parameters; one or more of: time division multiplexing (TDM) the one or more RSs with a second transmission; assigning the one or more RSs to one or more indicated symbols; or assigning the one or more RSs to one or more dedicated symbols within a slot, the one or more dedicated symbols including symbol features dedicated for RSs.

In some implementations of the method and apparatuses for a UE described herein, a slot or a subframe that includes one or more RS symbols includes differing parameters or characteristics than a slot or a subframe that does not include one or more RS symbols; one or more of: one or more of RS symbol parameters, RS symbol slot format, or RS subframe format are indicated via reference to a codebook; or a codebook for RS is associated with one or more of a transmission direction or a low resolution feature of the UE; one or more of: the one or more RSs are TDM as part of a defined symbol; or the one or more RSs are TDM within a shared symbol with a second transmission; one or more of: transmission of the one or more RSs at a symbol including an IFFT stage includes shaping dedicated REs for time-domain shaping; or transmission of the one or more RSs at a symbol including an IFFT stage includes adjusting an IFFT length to a RS duration and multiplexing the one or more RSs at a post-IFFT stage; the one or more RSs are TDM within a symbol with modulated RS samples at time-samples corresponding to a CP of an associated signal at a pre-CP insertion stage.

In some implementations of the method and apparatuses for a UE described herein, the method further comprises generating the one or more RSs using a digital quantization step from one or more supported digital quantization steps of the UE; generating the one or more RSs using digital quantization at one or more of: after an IFFT stage and prior to CP insertion; after the IFFT stage and after CP insertion; after an upsampling and filtering stage; or after a RS generated in time domain; adjusting one or more parameters of the one or more RSs to be within a discrete space prior to transmission of the one or more RSs; transmitting an indication of the adjusted one or more parameters of the one or more RSs.

Some implementations of the method and apparatuses described herein may include a UE for wireless communication to receive first capability information including one or more low-resolution transmit behaviors of a radio node, and one or more RSs; receive third configuration information including an indication of one or more measurement quantities to be computed based at least in part on the RSs; and transmit a measurement report generated based at least in part on the third configuration information, the measurement report including the one or more measurement quantities.

In some implementations of the method and apparatuses described herein, the at least one processor is configured to cause the UE to receive an indication of an association between the one or more RSs and one or more other transmissions; the third configuration information includes an indication that the measurement report is to be generated using one or more RSs that meet a distortion condition.

Some implementations of the method and apparatuses described herein may further include a processor for wireless communication to receive first capability information including one or more low-resolution transmit behaviors of a radio node, and one or more RSs; receive third configuration information including an indication of one or more measurement quantities to be computed based at least in part on the RSs; and transmit a measurement report generated based at least in part on the third configuration information, the measurement report including the one or more measurement quantities.

Some implementations of the method and apparatuses described herein may further include a method performed by a UE, the method including receiving first capability information including one or more low-resolution transmit behaviors of a radio node, and one or more RSs; receiving third configuration information including an indication of one or more measurement quantities to be computed based at least in part on the RSs; and transmitting a measurement report generated based at least in part on the third configuration information, the measurement report including the one or more measurement quantities.

In some implementations of the method and apparatuses described herein, the method further comprising receiving an indication of an association between the one or more RSs and one or more other transmissions; the third configuration information includes an indication that the measurement report is to be generated using one or more RSs that meet a distortion condition.

Some implementations of the method and apparatuses described herein may further include a NE for wireless communication to transmit first capability information including one or more low-resolution transmit behaviors of the NE; receive second configuration information for transmission of a RS; and transmit, based at least in part on the second configuration information, one or more RSs.

In some implementations of the method and apparatuses described herein, the one or more low-resolution transmit behaviors of the NE are associated with a low resolution DAC of the NE, and the RS includes a sequence of time-domain complex values; the first capability information includes capability information for the NE, the capability information including one or more of: a discrete set as a subset of one or more supported steps of one or more DACs of the NE; a first value equal to or smaller than a number of quantization states supported by the one or more DACs of the NE; a second value equal to or smaller than a number of quantization bits supported by the one or more DACs of the NE; or at least one supported sampling time of the one or more DACs of the NE;

the second configuration information includes one or more of: a sequence of complex values defined in time-domain as an output of a digital baseband processor; a defined sequence of complex values defined in the time-domain as input of one or more DACs of the NE; one or more of a sampling time or a sampling rate associated with the defined sequence of complex values; a scaling value applied on the defined sequence of complex values; a phase rotation applied on the define complex sequence of complex values; a reference to one or more previous RSs; or different RS definitions for multiple different transmission directions; the at least one processor is configured to cause the NE to autonomously determine one or more RS parameters.

In some implementations of the method and apparatuses described herein, the at least one processor is configured to cause the NE to one or more of: TDM the one or more RSs with a second transmission; assign the one or more RSs to one or more indicated symbols; or assign the one or more RSs to one or more dedicated symbols within a slot, the one or more dedicated symbols including symbol features dedicated for RSs; a slot or a subframe that includes one or more RS symbols includes differing parameters or characteristics than a slot or a subframe that does not include one or more RS symbols; one or more of: one or more of RS symbol parameters, RS symbol slot format, or RS subframe format are indicated via reference to a codebook; or a codebook for RS is associated with one or more of a transmission direction or a low resolution feature of the NE; one or more of: the one or more RSs are TDM as part of a defined symbol; or the one or more RSs are TDM within a shared symbol with a second transmission; one or more of: transmission of the one or more RSs at a symbol including an IFFT stage includes shaping dedicated REs for time-domain shaping; or transmission of the one or more RSs at a symbol including an IFFT stage includes adjusting an IFFT length to a RS duration and multiplexing the one or more RSs at a post-IFFT stage.

In some implementations of the method and apparatuses described herein, the one or more RSs are TDM within a symbol with modulated RS samples at time-samples corresponding to a CP of an associated signal at a pre-CP insertion stage; the at least one processor is configured to cause the NE to generate the one or more RSs using a digital quantization step from one or more supported digital quantization steps of the NE; the at least one processor is configured to cause the NE to generate the one or more RSs using digital quantization at one or more of: after an IFFT stage and prior to CP insertion; after the IFFT stage and after CP insertion; after an upsampling and filtering stage; or after a RS generated in time domain; the at least one processor is configured to cause the NE to adjust one or more parameters of the one or more RSs to be within a discrete space prior to transmission of the one or more RSs; the at least one processor is configured to cause the NE to transmit an indication of the adjusted one or more parameters of the one or more RSs.

Some implementations of the method and apparatuses described herein may further include a method performed by a NE, the method including transmitting first capability information including one or more low-resolution transmit behaviors of the NE; receiving second configuration information for transmission of a RS; and transmitting, based at least in part on the second configuration information, one or more RSs.

In some implementations of the method and apparatuses for a NE described herein, the one or more low-resolution transmit behaviors of the NE are associated with a low resolution DAC of the NE, and the RS includes a sequence of time-domain complex values; the first capability information includes capability information for the NE, the capability information including one or more of: a discrete set as a subset of one or more supported steps of one or more DACs of the NE; a first value equal to or smaller than a number of quantization states supported by the one or more DACs of the NE; a second value equal to or smaller than a number of quantization bits supported by the one or more DACs of the NE; or at least one supported sampling time of the one or more DACs of the NE; the second configuration information includes one or more of: a sequence of complex values defined in time-domain as an output of a digital baseband processor; a defined sequence of complex values defined in the time-domain as input of one or more DACs of the NE; one or more of a sampling time or a sampling rate associated with the defined sequence of complex values; a scaling value applied on the defined sequence of complex values; a phase rotation applied on the define complex sequence of complex values; a reference to one or more previous RSs; or different RS definitions for multiple different transmission directions; autonomously determining one or more RS parameters.

In some implementations of the method and apparatuses for a NE described herein, one or more of: time division multiplexing (TDM) the one or more RSs with a second transmission; assigning the one or more RSs to one or more indicated symbols; or assigning the one or more RSs to one or more dedicated symbols within a slot, the one or more dedicated symbols including symbol features dedicated for RSs; a slot or a subframe that includes one or more RS symbols includes differing parameters or characteristics than a slot or a subframe that does not include one or more RS symbols; one or more of: one or more of RS symbol parameters, RS symbol slot format, or RS subframe format are indicated via reference to a codebook; or a codebook for RS is associated with one or more of a transmission direction or a low resolution feature of the NE; one or more of: the one or more RSs are TDM as part of a defined symbol; or the one or more RSs are TDM within a shared symbol with a second transmission; one or more of: transmission of the one or more RSs at a symbol including an IFFT stage includes shaping dedicated REs for time-domain shaping; or transmission of the one or more RSs at a symbol including an IFFT stage includes adjusting an IFFT length to a RS duration and multiplexing the one or more RSs at a post-IFFT stage.

In some implementations of the method and apparatuses for a NE described herein, the one or more RSs are TDM within a symbol with modulated RS samples at time-samples corresponding to a CP of an associated signal at a pre-CP insertion stage; generating the one or more RSs using a digital quantization step from one or more supported digital quantization steps of the NE; generating the one or more RSs using digital quantization at one or more of: after an IFFT stage and prior to CP insertion; after the IFFT stage and after CP insertion; after an upsampling and filtering stage; or after a RS generated in time domain; adjusting one or more parameters of the one or more RSs to be within a discrete space prior to transmission of the one or more RSs; transmitting an indication of the adjusted one or more parameters of the one or more RSs.

Some implementations of the method and apparatuses described herein may further include a NE for wireless communication to receive first capability information including one or more low-resolution transmit behaviors of a radio node, and one or more RSs; receive third configuration information including an indication of one or more measurement quantities to be computed based at least in part on the RSs; and transmit a measurement report generated based at least in part on the third configuration information, the measurement report including the one or more measurement quantities.

In some implementations of the method and apparatuses described herein, the at least one processor is configured to cause the NE to receive an indication of an association between the one or more RSs and one or more other transmissions; the third configuration information includes an indication that the measurement report is to be generated using one or more RSs that meet a distortion condition.

Some implementations of the method and apparatuses described herein may further include a method performed by a NE, the method including receiving first capability information including one or more low-resolution transmit behaviors of a radio node, and one or more RSs; receiving third configuration information including an indication of one or more measurement quantities to be computed based at least in part on the RSs; and transmitting a measurement report generated based at least in part on the third configuration information, the measurement report including the one or more measurement quantities.

In some implementations of the method and apparatuses described herein, the method further comprising receiving an indication of an association between the one or more RSs and one or more other transmissions; the third configuration information includes an indication that the measurement report is to be generated using one or more RSs that meet a distortion condition.

### BRIEF DESCRIPTION OF THE DRAWINGS

FIG. 1 illustrates an example of a wireless communications system in accordance with aspects of the present disclosure.

FIG. 2 illustrates a scenario 200 for EVM measurement points according to one or more implementations.

FIG. 3 illustrates an EVM calculation block diagram 300 for 2-Layer uplink multiple input multiple output (MIMO) according to one or more implementations.

FIG. 4 illustrates an example wireless link diagram 400 in accordance with aspects of the present disclosure.

FIG. 5 illustrates an example scenario 500 in accordance with aspects of the present disclosure.

FIG. 6 illustrates an example 600 for radio node transmission in accordance with aspects of the present disclosure.

FIG. 7 illustrates an example implementation 700 for generating DT-RS in accordance with aspects of the present disclosure.

FIG. 8 illustrates example scenarios 800 for TDM of DT-RS in accordance with aspects of the present disclosure.

FIG. 9 illustrates an example 900 for DT-RS generation in accordance with aspects of the present disclosure.

FIG. 10 illustrates an example 1000 for DT-RS generation in accordance with aspects of the present disclosure.

FIG. 11 illustrates an example 1100 for DT-RS generation in accordance with aspects of the present disclosure.

FIG. 12 illustrates an example 1200 for generation of DT-RS in accordance with aspects of the present disclosure.

FIG. 13 illustrates examples 1300 for generation of DT-RS in accordance with aspects of the present disclosure.

FIG. 14 illustrates an example of a UE 1400 in accordance with aspects of the present disclosure.

FIG. 15 illustrates an example of a processor 1500 in accordance with aspects of the present disclosure.

FIG. 16 illustrates an example of a NE 1600 in accordance with aspects of the present disclosure.

FIG. 17 illustrates a flowchart of a method 1700 in accordance with aspects of the present disclosure.

FIG. 18 illustrates a flowchart of a method 1800 in accordance with aspects of the present disclosure.

### DETAILED DESCRIPTION

In a wireless communications system, a UE and a NE (e.g., a base station, gNB) may support wireless communication (e.g., reception and/or transmission of wireless communication) using time-frequency resources. DACs are utilized at different nodes of a wireless communication system to enable wireless communication using time-frequency resources, including at the UE and NE. For instance, DACs are used in the analog front-end (AFE) of transceivers to handle high-speed data conversion, enabling efficient transmission and reception of signals. Some DACs are integrated into system-on-chip (SoC) designs for wireless transceivers and can support different frequency bands including sub-6 GHZ (FR1) and millimeter-wave (FR2) frequency bands. DACs, however, can account for a significant percentage of energy consumption at different nodes of a wireless communication system.

Due to a substantially lower complexity, cost, and energy consumption, low resolution (LR) DACs show potential for reduced link energy consumption as well as to facilitate up-scaling of a number of digital chains, which can reduce the per-chain component cost. A LR DAC, for instance, represents a DAC that is configured to utilize much fewer quantization steps than does a higher-resolution DAC. For example, when link performance is not dominated by the quantization resolution (e.g., in high resolution DAC scenarios), the utilization of a beam and/or radio chain with LR DAC can result in an improved energy efficiency. Nevertheless, realizing potential gains of LR radios may involve modifying steps associated with channel estimation of a wireless link associated with an LR radio, channel equalization of the link terminated at an LR radio, as well as link adaptation (e.g., transmit (Tx) power and modulation and coding scheme (MCS) adjustments for the link associated with a LR radio) in light of the non-linear LR quantization effect that may result from utilizing LR DACs.

In particular, utilization of an LR DAC can lead to additional Tx quantization distortion for transmission of modulated data and control information as well as degraded channel estimation and equalization. These effects can occur, for example, when variations on standard RS transmission and generation are used, e.g., the downlink (DL) channel state information (CSI)-RS or DL physical downlink shared channel (PDSCH) demodulation reference signal (DMRS) modulated over a CP-OFDM waveform. In particular, the aforementioned RS generation schemes can be prone to additive quantization distortions when quantized with LR DACs and can lead to a degraded channel estimation and equalization quality.

Aspects of the present disclosure are described in the context of a wireless communications system, and include implementations that provide solutions that can minimize the impact of quantization distortion in CSI estimation in wireless communications scenarios that utilize LR DACs.

For example, implementations describe a RS defined and/or described at the output stage of the digital processor and/or input stage of the DAC including a sequence of time-domain discrete values according to the DACs discrete steps and the DAC's input sampling time. In implementations the RS is referred to herein as a discrete time-domain RS (DT-RS) but implementations are applicable to a wide variety of RS implementations and/or types. DT-RS types can include DL, uplink (UL), sidelink (SL), TRP-TRP, and DT-RS types, just to name a few.

Implementations also include solutions for indications of capability information by an LR radio node, including that a radio node includes an LR DAC, supported DAC discrete states and/or levels, baseband sampling rates, etc. Indications are also provided for a signal specific Tx signal-to-noise ratio (SNR)/error vector magnitude (EVM) condition, e.g., RS transmission being associated with a specific Tx impairment condition of a high Tx SNR/low EVM (e.g., for a DT-RS) or a low-Tx SNR/high EVM for a second transmission.

Implementations also provide for indications of a measurement report to be generated based on signals indicated as being DT-RS and/or signals with low EVM conditions among a plurality of configured transmissions. Further, a relation is described between a first DT-RS and a second RS sharing one or more features of a Tx SNR/EVM level, LR condition, and/or time-domain sampling rate. For instance, a DT-RS transmission can be associated with an RS transmission with zero or low EVM. In examples, an indication is described of the time-domain baseband sampling rate of a radio node and/or DT-RS when different from a default sampling rate of a radio for transmission/reception for which the DT-RS is configured. Further, a quasi co-location (QCL) relation is described between two transmissions including indication of a high/different Tx SNR, Tx EVM, or low/zero quantization distortion present at one of the transmissions.

Implementations also enable a first DT-RS to be TDM with a second transmission (e.g., another DT-RS, other RS, a physical channel, etc.) according to one or more of a first DT-RS transmission at dedicated (e.g., dynamic or statically) symbols, a new slot/subframe format with provisioning of DL/UL/SL DT-RS symbols with specific symbol parameters for DT-RS transmission, and/or according to a codebook defining slot format with presence of DT-RS symbols. Further, a first DT-RS can be TDM with a second transmission (e.g., of another DT-RS and/or RS, a physical channel, etc.), according to a first DT-RS transmission at a shared symbol with a second transmission, shaping of dedicated REs for time-domain shaping, and/or adjusted IFFT length to the time-domain DT-RS duration and multiplexing of the DT-RS at the post-IFFT stage. In implementations DT-RS can be TDM inside a symbol with modulated samples at time-samples corresponding to the CP of a signal at the pre-CP insertion stage, which can double the RS time domain presence. Implementations also provide for generation of DT-RS utilizing a known RS (e.g., CSI-RS) and a digital quantization step, and self-adjustment of the phase and/or scaling/amplitude of a configured RS for transmission by a radio node and indication of the adjusted RS parameters according to an LR condition of the first radio node.

By performing the described techniques, devices in a wireless communications system can utilize LR radios (e.g., LR DACs) for wireless communication while minimizing effects of LR radio utilization on signal quality. Thus, energy usage can be conserved while mitigating effects of such energy conservation on signal quality.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

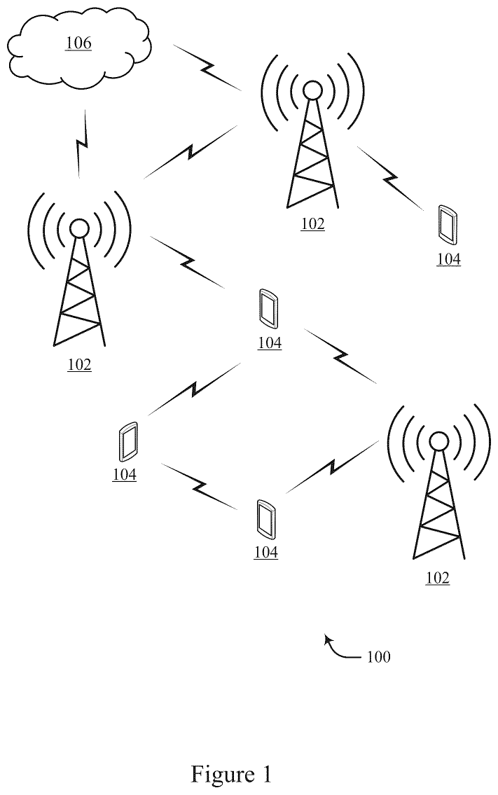

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (e.g., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHZ-7.125 GHZ), FR2 (24.25 GHz-52.6 GHZ), FR3 (7.125 GHZ-24.25 GHZ), FR4 (52.6 GHz-114.25 GHZ), FR4a or FR4-1 (52.6 GHz-71 GHZ), and FR5 (114.25 GHZ-300 GHz). In some implementations, the NEs 102 and the UEs 104 may perform wireless communications over one or more of the operating frequency bands. In some implementations, FRI may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. An NE 102 and/or a UE 104, for instance, can be referred to as a first radio node and/or a second radio node, or vice-versa. According to implementations, a first radio node transmits to a second radio node first capability information including one or more low-resolution transmit behaviors of the first radio node. The first radio node receives second configuration information for transmission of a RS, and transmits, based at least in part on the second configuration information, one or more RSs. According to implementations, a second radio node receives, from a first radio node, first capability information comprising one or more low-resolution transmit behaviors of a first radio node, and one or more RSs. The second radio node receives third configuration information comprising an indication of one or more measurement quantities to be computed based at least in part on the RSs, and transmits a measurement report generated based at least in part on the third configuration information, the measurement report comprising the one or more measurement quantities.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

With reference to sounding reference signal (SRS), an SRS resource can be configured by the SRS-Resource information element (IE) or the SRS-PosResource IE and consists of:

$${N}_{ap}^{SRS} ∈$$

{1,2,4} antenna ports

$${\{ {p}_{i} \}}_{i = 0}^{{N}_{ap}^{SRS} - 1} ,$$

where the number of antenna ports is given by the higher layer parameter nrofSRS-Ports if configured, otherwise

$${N}_{ap}^{SRS} = 1 ,$$

and pᵢ=1000+i when the SRS resource is in a SRS resource set with higher-layer parameter usage in SRS-ResourceSet not set to ‘nonCodebook’, or determined according to [3GPP technical specification (TS) 38.214] when the SRS resource is in a SRS resource set with higher-layer parameter usage in SRS-ResourceSet set to ‘nonCodebook’

$${N}_{symb}^{SRS} ∈$$

{1, 2, 4, 8, 10, 12, 14} consecutive OFDM symbols given by the field nrofSymbols contained in the higher layer parameter resourceMapping
l₀, the starting position in the time domain given by

$${l}_{0} = {N}_{symb}^{slot} - 1 - {l}_{offset}$$

where the offset l_{offset} ∈{0, 1, . . . , 13} counts symbols backwards from the end of the slot and is given by the field startPosition contained in the higher layer parameter resourceMapping and

$${l}_{offset} \geq {N}_{s y m b}^{S R S} - 1$$

k₀, the frequency-domain starting position of the SRS

The SRS sequence for an SRS resource can be generated according to

$${r}^{( {p}_{i} )} ( n , {l}^{′} ) = {r}_{u , v}^{( {α}_{i} , δ )} ( n ) \\ 0 \leq n \leq {M}_{sc , b}^{S R S} - 1 \\ {l}^{′} ∈ \{ 0 , 1 , … , {N}_{s y m b}^{S R S} - 1 \}$$

where

$${M}_{sc , b}^{S R S}$$

is given by TS 38.101-1 clause 6.4.1.4.3,

$${r}_{u , v}^{( α , δ )} ( n )$$

is given by TS 38.101-1 clause where 5.2.2 with δ=log, (K_{TC}) and the transmission comb number K_{TC} ∈{2, 4, 8} is contained in the higher-layer parameter transmissionComb. The cyclic shift αᵢ for antenna port pᵢ is given as

$${α}_{i} = 2 π \frac{{n}_{SRS}^{cs , i}}{{n}_{SRS}^{cs , max}} \\ {n}_{S R S}^{cs , i} = \{ \begin{matrix}\begin{matrix} \\ \end{matrix} ( {n}_{S R S}^{cs} + \frac{{n}_{SRS}^{cs , max} ⌊ ( {p}_{i} - 1000 ) / 2 ⌋}{{N}_{ap}^{SRS}} ) mod {n}_{SRS}^{cs , max} & \begin{matrix}if {N}_{ap}^{SRS} = 4 and \\ {n}_{SRS}^{cs , max} = 6\end{matrix} \\ ( {n}_{S R S}^{cs} + \frac{{n}_{SRS}^{cs , max} ( {p}_{i} - 1000 )}{{N}_{ap}^{SRS}} ) mod {n}_{SRS}^{cs , max} & otherwise\end{matrix} ,$$

where

$${n}_{S R S}^{c s} ∈ \{ 0 , 1 , … , {n}_{S R S}^{cs , max} - 1 \}$$

is contained in the higher layer parameter transmissionComb.

The maximum number of cyclic shifts

$${n}_{S R S}^{cs , max}$$

are given by Table 1 (below). The sequence group

$$u = ( {f}_{g h} ( {n}_{s , f}^{μ} , {l}^{′} ) + {n}_{ID}^{S R S} ) mod 30$$

and the sequence number v in TS 38.101-1 clause 5.2.2 depends on the higher-layer parameter groupOrSequenceHopping in the SRS-Resource IE or the SRS-PosResource IE. The SRS sequence identity

$${n}_{ID}^{S R S}$$

is given by the higher layer parameter sequenceId in the SRS-Resource IE, in which case

$${n}_{ID}^{S R S} ∈ \{ 0 , 1 , … , 1023 \} ,$$

or the SRS-PosResource-r16 IE, in which case

$${n}_{ID}^{SRS} ∈ \{ 0 , 1 , … , 65535 \} .$$

The quantity

$${l}^{′} ∈ \{ 0 , 1 , … , {N}_{s y m b}^{S R S} - 1 \}$$

is the OFDM symbol number within the SRS resource.

If groupOrSequenceHopping equals ‘neither’, neither group, nor sequence hopping can be used and

$${f}_{g h} ( {n}_{s , f}^{μ} , {l}^{′} ) = 0 \\ v = 0$$

If groupOrSequenceHopping equals ‘groupHopping’, group hopping but not sequence hopping can be used and

$${f}_{g h} ( {n}_{s , f}^{μ} , {l}^{′} ) = ( {\sum }_{m = {0}^{}}^{7} c ( 8 ( {n}_{s , f}^{μ} {N}_{symb}^{slot} + {l}_{0} + {l}^{′} ) + m ) \cdot {2}^{m} ) mod 30 \\ v = 0$$

where the pseudo-random sequence c (i) is defined by TS 38.101-1 clause 5.2.1 and can be initialized with

$${c}_{i n i t} = {n}_{ID}^{S R S}$$

at the beginning of each radio frame.

If groupOrSequence Hopping equals ‘sequenceHopping’, sequence hopping but not group hopping can be used and

$${f}_{g h} ( {n}_{s , f}^{μ} , {l}^{′} ) = 0 \\ v = \{ \begin{matrix}c ( {n}_{s , f}^{μ} {N}_{symb}^{slot} + {l}_{0} + {l}^{′} ) & {M}_{sc , b}^{SRS} \geq 6 {N}_{sc}^{RB} \\ 0 & otherwise\end{matrix}$$

where the pseudo-random sequence c (i) is defined by TS 38.101-1 clause 5.2.1 and can be initialized with

$${c}_{init} = {n}_{ID}^{SRS}$$

at the beginning of each radio frame.

TABLE 1
Maximum number of cyclic shifts n_{SRS}^{cs, max} as a function of K_{TC}.

| K_{TC} | n_{SRS}^{cs, max} |
|---|---|
| 2 | 8 |
| 4 | 12 |
| 8 | 6 |

Regarding mapping to physical resources, when SRS is transmitted on a given SRS resource, the sequence r^{(p}^{ᵢ}⁾ (n, l′) for each OFDM symbol l′ and for each of the antenna ports of the SRS resource can be multiplied with the amplitude scaling factor β_{SRS} in order to conform to the transmit power specified in [5, 38.213] and mapped in sequence starting with r^{(p}^{ᵢ}⁾ (0,l′) to resource elements (k,l) in a slot for each of the antenna ports pᵢ according to

$${a}_{{K}_{TC} {k}^{′} + {k}_{0}^{( {p}_{i} )} , {l}^{′} + {l}_{0}}^{( {p}_{i} )} = \{ \begin{matrix}\frac{1}{\sqrt{{N}_{ap}}} {β}_{SRS} {r}^{( {p}_{i} )} ( {k}^{′} , {l}^{′} ) & {k}^{′} = 0 , 1 , … , {M}_{sc , b}^{SRS} - 1 & {l}^{′} = 0 , 1 , … , {N}_{symb}^{SRS} - 1 \\ 0 & otherwise & \end{matrix}$$

The length of the SRS sequence is given by

$${M}_{sc , b}^{SRS} = {m}_{SRS , b} {N}_{sc}^{RB} / ( {K}_{TC} {P}_{F} )$$

where m_{SRS,b} is given by a selected row of Table 6.4.1.4.3-1 of TS 38.101-1 with b=BSRs where BSRS={0, 1, 2, 3} is given by the field b-SRS contained in the higher-layer parameter freqHopping if configured, otherwise B_{SRS}=0. The row of the table is selected according to the index C_{SRS}={0, 1, . . . , 63} given by the field c-SRS contained in the higher-layer parameter freqHopping. The quantity P_{F}∈{2, 4} is given by the higher-layer parameter FreqScalingFactor if configured, otherwise P_{F}=1. When FreqScalingFactor is configured, the UE expects the length of the SRS sequence to be a multiple of 6.

The frequency-domain starting position

$${k}_{0}^{( {p}_{i} )}$$

is defined by

$$\begin{matrix}\begin{matrix}\begin{matrix}\begin{matrix}{k}_{0}^{( {p}_{i} )} = {\overline{k}}_{0}^{( {p}_{i} )} + {n}_{offset}^{FH} + {n}_{offset}^{RPFS} \\ where\end{matrix} \\ {\overline{k}}_{0}^{( {p}_{i} )} = {n}_{shift} {N}_{sc}^{RB} + ( {k}_{TC}^{( {p}_{i} )} + {k}_{offset}^{{l}^{′}} ) mod {K}_{TC}\end{matrix} \\ {k}_{TC}^{( {p}_{i} )} = \{ \text{} \begin{matrix}( {\overline{k}}_{TC} + {K}_{TC} / 2 ) mod {K}_{TC} & if {N}_{ap}^{SRS} = 4 , {p}_{i} ∈ \{ 1001 , 1003 \} , and {n}_{SRS}^{cs , max} = 6 \\ ( {\overline{k}}_{TC} + {K}_{TC} / 2 ) mod {K}_{TC} & if {N}_{ap}^{SRS} = 4 , {p}_{i} ∈ \{ 1001 , 1003 \} , and {n}_{SRS}^{cs} ∈ \{ {n}_{SRS}^{cs , max} / 2 , … , {n}_{SRS}^{cs , max} - 1 \} \\ {\overline{k}}_{TC} & otherwise\end{matrix}\end{matrix} \\ \begin{matrix}{n}_{offset}^{FH} = {\sum }_{b = 0}^{{B}_{SRS}} {m}_{SRS , b} {N}_{sc}^{RB} {n}_{b} \\ {n}_{offset}^{RPFS} = {N}_{sc}^{RB} {m}_{SRS , {B}_{SRS}} ( ( {k}_{f} + {k}_{hop} ) mod {P}_{F} ) / {P}_{F}\end{matrix}\end{matrix}$$

and
k_{F}∈{0, 1, . . . , P_{F}−1} is given by the higher-layer parameter StartRBIndex if configured, otherwise k_{F}=0;
kₕₒₚ is given by Table 6.4.1.4.3-3 of TS 38.101-1 with

$$\begin{matrix}{\overline{k}}_{hop} = ⌊ \frac{{n}_{SRS}}{{Π}_{{b}^{′} = {b}_{hop}}^{{B}_{SRS}} {N}_{b ′}} ⌋ mod {P}_{F} \\ {N}_{{b}_{hop}} = 1\end{matrix}$$

if the higher-layer parameter EnableStartRBHopping is configured, otherwise kₕₒₚ=0.

If

$${N}_{BWP}^{start} \leq {n}_{shift}$$

the reference point for

$${k}_{0}^{( {p}_{i} )} = 0$$

is subcarrier 0 in common resource block 0, otherwise the reference point is the lowest subcarrier of the bandwidth part (BWP). If the SRS is configured by the IE SRS-PosResource, the quantity

$${k}_{offset}^{{l}^{′}}$$

is given by Table 6.4.1.4.3-2 of TS 38.101-1, otherwise

$${k}_{offset}^{{l}^{′}} = 0.$$

The frequency domain shift value n_{shift} adjusts the SRS allocation with respect to the reference point grid and is contained in the higher-layer parameter freqDomainShift in the SRS-Resource IE or the SRS-PosResource IE. The transmission comb offset k̅_{TC} ∈{0, 1, . . . , K_{TC}−1} is contained in the higher-layer parameter transmissionComb in the SRS-Resource IE or the SRS-PosResource IE and n_{b} is a frequency position index.

Frequency hopping of the SRS is configured by the parameter bₕₒₚ∈{0, 1, 2, 3}, given by the field b-hop contained in the higher-layer parameter freqHopping if configured, otherwise bₕₒₚ=0. If bₕₒₚ≥B_{SRS}, frequency hopping is disabled and the frequency position index ng remains constant (unless re-configured) and is defined by

$${n}_{b} = ⌊ 4 {n}_{RRC} / {m}_{SRS , b} ⌋ mod {N}_{b}$$

for all

$${N}_{symb}^{SRS}$$

OFDM symbols of the SRS resource. The quantity n_{RRC} is given by the higher-layer parameter freqDomainPosition if configured, otherwise n_{RRC}=0, and the values of m_{SRS,b} and N_{b} for b=B_{SRS} are given by the selected row of Table 6.4.1.4.3-1 of TS 38.101-1 corresponding to the configured value of c_{SRS}.

If bₕₒₚ<B_{SRS}, frequency hopping is enabled and the frequency position indices n_{b} are defined by

$${n}_{b} = \{ \begin{matrix}⌊ 4 {n}_{RRC} / {m}_{SRS , b} ⌋ mod {N}_{b} & b \leq {b}_{hop} \\ ( {F}_{b} ( {n}_{SRS} ) + ⌊ 4 {n}_{RRC} / {m}_{SRS , b} ⌋ ) mod {N}_{b} & otherwise\end{matrix}$$

where N_{b} is given by Table 6.4.1.4.3-1 of TS 38.101-1,

$${F}_{b} ( {n}_{SRS} ) = \{ \begin{matrix}( {N}_{b} / 2 ) ⌊ \frac{{n}_{SRS} mod {Π}_{{b}^{′} = {b}_{hop}}^{b} {N}_{{b}^{′}}}{{Π}_{{b}^{′} = {b}_{hop}}^{b - 1} {N}_{{b}^{′}}} ⌋ + ⌊ \frac{{n}_{SRS} mod {Π}_{{b}^{′} = {b}_{hop}}^{b} {N}_{{b}^{′}}}{2 {Π}_{{b}^{′} = {b}_{hop}}^{b - 1} {N}_{{b}^{′}}} ⌋ & if {N}_{b} even \\ ⌊ {N}_{b} / 2 ⌋ ⌊ {n}_{SRS} / {Π}_{{b}^{′} = {b}_{hop}}^{b - 1} {N}_{{b}^{′}} ⌋ & if {N}_{b} odd\end{matrix}$$

and where N_{b}_{ₕₒₚ}=1 regardless of the value of N_{b}. The quantity n_{SRS} counts the number of SRS transmissions. For the case of an SRS resource configured as aperiodic by the higher-layer parameter resourceType, it is given by n_{SRS}=└l′/R┘ within the slot in which

$${N}_{symb}^{SRS}$$

symbol SRS resource is transmitted. The quantity

$$R \leq {N}_{symb}^{SRS}$$

is the repetition factor given by the field repetitionFactor if configured, otherwise

$$R = {N}_{symb}^{SRS} .$$

For the case of an SRS resource configured as periodic or semi-persistent by the higher-layer parameter resourceType, the SRS counter is given by

$${n}_{SRS} = ( \frac{{N}_{slot}^{frame , μ} {n}_{f} + {n}_{s , f}^{μ} - {T}_{offset}}{{T}_{SRS}} ) \cdot ( \frac{{N}_{symb}^{SRS}}{R} ) + ⌊ \frac{r}{R} ⌋$$

for slots that satisfy

$$( {N}_{slot}^{frame , μ} {n}_{f} + {n}_{s , f}^{μ} - {T}_{offset} ) mod {T}_{SRS} = 0 .$$

The periodicity T_{SRS} in slots and slot offset T_{offset} are given in clause 6.4.1.4.4 of TS 38.101-1.

The EVM is a measure of the difference between the reference waveform and the measured waveform. This difference is called the error vector. Before calculating the EVM the measured waveform is corrected by the sample timing offset and radio frequency (RF) frequency offset. Then the carrier leakage can be removed from the measured waveform before calculating the EVM.

The measured waveform is further equalized using the channel estimates subjected to the EVM equalizer spectrum flatness requirement specified in clause 6.4.2.4 of TS 38.101-1. For Discrete Fourier Transform-spread-Orthogonal Frequency Division Multiplexing (DFT-s-OFDM) waveforms, the EVM result is defined after the front-end Fast Fourier Transform (FFT) and Inverse Discrete Fourier Transformation (IDFT) as the square root of the ratio of the mean error vector power to the mean reference power expressed as a %. For CP-OFDM waveforms, the EVM result is defined after the front-end FFT as the square root of the ratio of the mean error vector power to the mean reference power expressed as a %.

The basic EVM measurement interval in the time domain is one preamble sequence for the physical random access channel (PRACH) and one slot for physical uplink control channel (PUCCH) and physical uplink shared channel (PUSCH) in the time domain. The EVM measurement interval is reduced by any symbols that contains an allowable power transient in the measurement interval, as defined in clause 6.3.3 of TS 38.101-1. The root mean square (RMS) average of the basic EVM measurements over 10 subframes for the average EVM case, and over 60 subframes for the RS EVM case, for the different modulation schemes cannot exceed the values specified in Table 2 below for the parameters defined in Table 3 below. For EVM evaluation purposes, all 13 PRACH preamble formats and all 5 PUCCH formats are considered to have the same EVM requirement as QPSK modulated.

TABLE 2
Requirements for Error Vector Magnitude

| Parameter | Unit | Average EVM Level |
|---|---|---|
| Pi/2-BPSK | % | 30 |
| QPSK | % | 17.5 |
| 16 QAM | % | 12.5 |
| 64 QAM | % | 8 |
| 256 QAM | % | 3.5 |

TABLE 3
Parameters for Error Vector Magnitude

| Parameter | Unit | Level |
|---|---|---|
| UE Output Power | dBm | ³ Table 6.3.1-1 of TS |
| | | 38.101-1 |
| UE Output Power for 256 | dBm | ³ Table 6.3.1-1 + 10 dB |
| QAM | | of TS 38.101-1 |

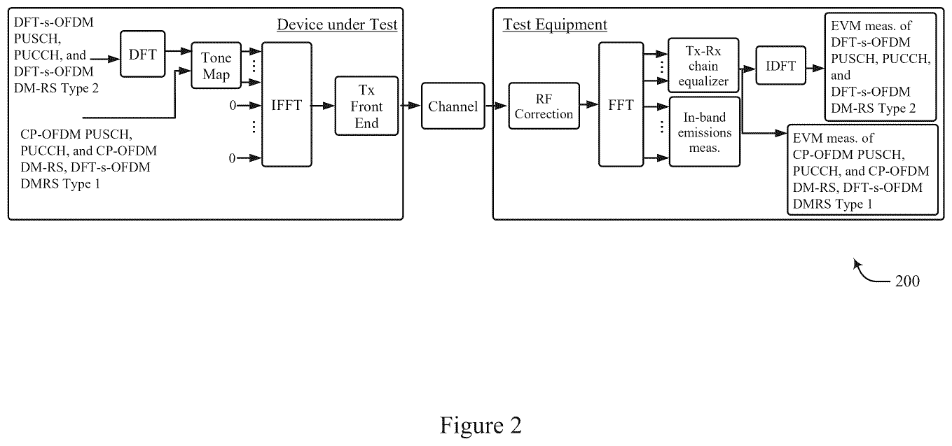

FIG. 2 illustrates a scenario 200 for EVM measurement points according to one or more implementations. The scenario 200 includes a device under test, a test equipment (TE), and shows a measurement point for the unwanted emission falling into non-allocated resource blocks (RB(s)) and the EVM for the allocated RB(s).

For UE with multiple transmission antennas, if UE indicates IE txDiversity-r16, EVM is measured at each antenna connector to get EVMᵢ, and the total EVM is calculated by values of EVMᵢ with weighting factor of linear power at each antenna connector.

$$EVM = \frac{{\sum }_{i = 1}^{k} {P}_{i} * {EVM}_{i}}{{\sum }_{i = 1}^{k} {P}_{i}}$$

where k=2, 4, and Pᵢ denotes the linear power measured at each antenna connector respectively.

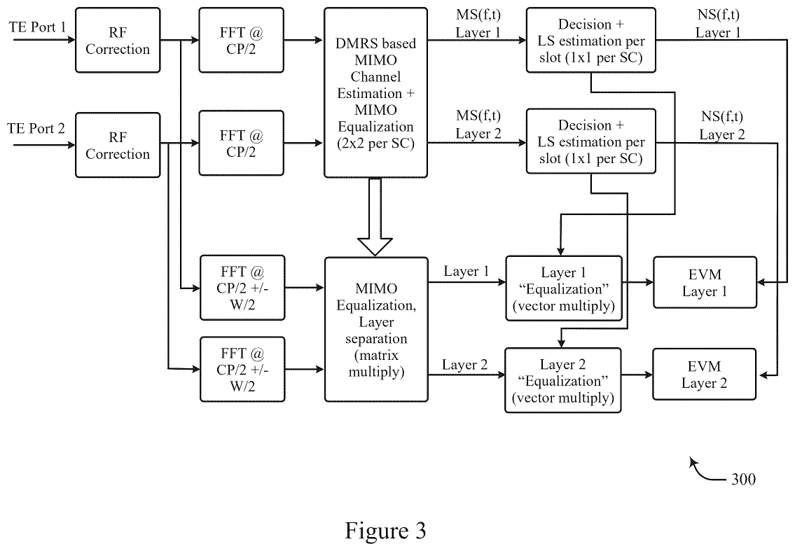

FIG. 3 illustrates an EVM calculation block diagram 300 for 2-Layer uplink multiple input multiple output (MIMO) according to one or more implementations. EVM for UL MIMO is measured per layer. A zero-forcing (ZF) MIMO receiver architecture is used so that dual layer transmissions by the UE can be demodulated by the test equipment receiver. In the block diagram 300 the TE receives signals from 2 different ports which are connected to two antenna connectors in the test system. For UL MIMO measurements a MIMO equalization step is performed to separate the layers. Each layer is then processed to receive the measurement results for each individual layer.

MIMO equalization can be based on RSs (DMRS) without using any data symbols. For the equalization process all available DMRS symbols can be used. The effective 2×2 channel matrix is estimated using RSs of different subcarriers, e.g. in case of DMRS antenna ports 0 and 2. In case that same subcarriers are used, e.g. DMRS antenna ports 0 and 1, a channel decomposition is necessary taking advantage of the orthogonal codes ws and w, and assuming identical channel coefficients for adjacent subcarriers of same code division multiplexing (CDM) group.

Effective channel including the precoding matrix P is:

$$\tilde{H} = HP = [ \begin{matrix}{\tilde{h}}_{0 , 0} & {\tilde{h}}_{0 , 1} \\ {\tilde{h}}_{1 , 0} & {\tilde{h}}_{1 , 1}\end{matrix} ]$$

$$with$$

$${\tilde{h}}_{n , v} = \frac{{y}_{n} {r}_{v}^{*}}{{\vert {r}_{v} \vert}^{2}}$$

where y denotes the received symbol on port index n and r the RS for layer index v.

Since RSs of a specific layer are transmitted only on subcarriers of one CDM group channel, interpolation can be needed in order to obtain channel coefficients for all subcarriers. Channel interpolation can be done using the channel coefficients of active CDM group in all other CDM groups. The channel coefficients used to calculate the equalizer coefficients are obtained after channel smoothing in frequency domain by computing the moving average of interpolated channel coefficients. The moving average window size can be 7. For subcarriers at or near the edge of allocation the window size can be reduced accordingly.

The ZF equalizer coefficients are calculated as the inverse of the effective channel matrix:

$${G}_{ZF} = {\tilde{H}}^{- 1}$$

After performing the MIMO equalization each layer is processed using the existing procedure as defined in Annex E of TS 38.521-1. Since the channel estimation is calculated only on the DMRS symbols, an averaging including all 14 symbols of one slot, e.g. data and RSs, is needed in order to minimize EVM. The averaging is achieved by the least square (LS) equalization method described for single layer in Annex E.3. of TS 38.521-1.

MS (f,t) and NS (f,t) are processed with a LS estimator, to derive one equalizer coefficient per time slot and per allocated subcarrier. EC (f) is defined for each layer as:

$${EC}_{v} ( f ) = \frac{{\sum }_{t = 0}^{13} {NS}_{v} ( f , t ) * {NS}_{v} ( f , t )}{{\sum }_{t = 0}^{13} {MS}_{v} ( f , t ) * {NS}_{v} ( f , t )}$$

With * denoting complex conjugation. EC (f) are used to equalize layer data symbols.

EVM equalizer spectral flatness is derived from equalizer coefficients for each layer as follows:

$${c}_{v} = \vert {EC}_{v} ( f ) \vert \sqrt{{\vert {g}_{v , 0} \vert}^{2} + {\vert {g}_{v , 1} \vert}^{2}}$$

Aspects of the present disclosure include solutions to reduce quantization distortion, such as scenarios where a transmitting device is using a LR transceiver. In the discussion herein, let D_{DAC} be the supported set of the discrete complex values by a pair of DACs associated with the real and imaginary parts of a transmitter chain. Furthermore, let Tₙ be a time-domain sequence of transmission complex samples at the input of the combined real and imaginary DACs, such that Tₙ∈D_{DAC}. Then, Q{Tₙ}=Tₙ where Q denotes complex-valued projection/quantization according to the discrete set D_{DAC}. In the other words, the transmission of the complex sequence Tₙ via the DACs can generate zero quantization distortion.

Utilizing the above observation, the following is proposed to facilitate CSI estimation for a wireless channel associated with an LR radio while minimizing the impact of Tx quantization distortion: (1) Introduction of discrete time-domain RS (DT-RS) and variations of the DT-RS generation and multiplexing as a discrete RS defined at the input stage of the combined DAC; and (2) CSI estimation (and other L1 measurements) of a wireless link associated with an LR radio, based on the transmission of a configured DT-RS by the LR radio.

It is understood that this disclosure is not limited to the single implementation and/or implementation elements individually, and one or more elements from one or more implementations may be combined to construct a new implementation. It is understood that the described implementations/examples below, although exemplified for DT-RS, are not limited to the use of DT-RS and any feature/steps within the examples/implementations can be further utilized for any RS type (not necessary with discrete value description as for DT-RS), e.g., a described RS behavior may be equivalently applied to DL/SL positioning reference signal (PRS), CSI-RS, UL SRS, PDSCH DMRS etc. Moreover, it is understood that the features defining DT-RS may not be limited to the features discussed herein and features of any known RS may be used to define/configure a DT-RS.

It is understood that description of the DAC of a radio chain and the associated quantization operation may include quantization operation of the real/in-phase part of the complex baseband signal and quantization operation of imaginary/quadrature part of the complex baseband signal implemented via separate DACs for the real and imaginary parts or implemented jointly for the real and imaginary parts (e.g., by quantizing separately the amplitude and phase of a complex valued sample). As such, when applicable, a reference within the implementations/examples discussed herein to the quantization or DAC operation may be understood to describe the equivalent quantization/DAC operation wherein an input complex-valued sample can be quantized into a complex output value, and wherein the separate operations of the DACs (e.g., of the real and imaginary parts or of the amplitude and phase parts) are considered implicit to the overall/equivalent DAC or quantization operation.

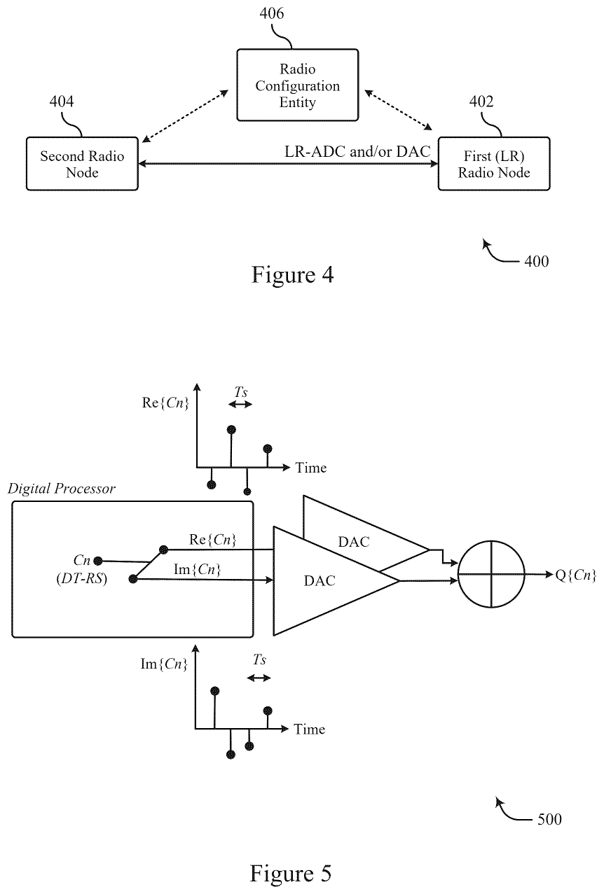

FIG. 4 illustrates an example wireless link diagram 400 in accordance with aspects of the present disclosure. The diagram 400 includes a first radio node 402, a second radio node 404, and a radio configuration entity 406. In the diagram 400 wireless communication can occur between the first radio node 402 and the second radio node 404, and the radio configuration entity 406 can configure radio behavior of the first radio node 402 and the second radio node 404, e.g., by collecting capability information of the radio nodes and defining and scheduling of RS transmission and measurement/reporting.

According to at least some implementations, the first radio node 402 is equipped with an LR DAC (and potentially a LR analog-to-digital converter (ADC)) and the second radio node 404 may be equipped with a high resolution (HR) DAC and/or ADCs. A high/low resolution condition of an ADC/DAC may be associated with (at least in part) supported number of quantization states or bits being above a threshold. For instance, a DAC with less than 7 quantization bits and ADC with less than 8 quantization bits may be referred to as an LR DAC/ADC and a radio chain equipped with an LR DAC and/or ADC may be referred to as an LR radio/chain). Further, a high/low resolution condition of an ADC/DAC may be associated with a specified level of the supported EVM or (maximum Tx) SNR or modulation error ratio (MER) at the Tx or Rx due to the impact of quantization distortion. In one example, a chain with (maximum Tx) SNR or MER of less than 40 dB due to the impact of quantization may be associated with an LR condition. In at least some examples LR can be considered as a radio property which may be considered as radio capability information.

In some examples of the diagram 400 including the first radio node 402, the second radio node 404, and the configuration entity 406: (1) the first radio node 402 can be a NE (e.g., gNB/RAN node) and the second radio node 404 can be a UE, where the radio configuration entity 406 can be co-located at the first radio node 402, e.g., LR gNB transmission; (2) the first radio node 402 can be a UE and the second radio node 404 can be a NE, where the radio configuration entity 406 can be co-located at the second radio node 404, e.g., LR UL UE transmission; (3) the first radio node 402 can be a first UE and the second radio node 404 can be a second UE. In some such examples, the radio configuration entity 406 can be co-located at the second radio node 404, at the first radio node 402, or at a third node (e.g., a NE associated with the first and/or second UE), e.g., LR UE SL transmission; (4) the first radio node 402 can be a NE (e.g., TRP/gNB/RAN node) and the second radio node 404 can be a NE (e.g., gNB/TRP node), where the radio configuration entity 406 can be co-located at the first or second radio node, or at a third entity, e.g., a location or sensing management function residing in RAN or at the core network, LMF, or sensing function (SF) residing at the CN or RAN.

FIG. 5 illustrates an example scenario 500 in accordance with aspects of the present disclosure. The scenario 500, for instance, represents an example implementation for transmission of DT-RS and includes a digital processor and a set of DACs. In the scenario 500 DT-RS is denoted as Cn with DAC sampling time denoted as Ts. Re{Cn} represents real representations of Cn, IM{Cn} represents imaginary representations of Cn, and Q{Cn} represents quantized Cn (e.g., quantized DT-RS). DT-RS can be defined at the output stage of the digital processor generating the DAC input and according to the sample timing of the DACs. In at least some examples, the two separate DACs are operating on the amplitude and phase of a complex input sample value, e.g., |Cn| and ZCn. A radio node (e.g., the first radio node 402 and/or the second radio node 404) can be self-configured, configured, and/or indicated by the configuration entity 406 for transmission of a DT-RS such as illustrated in the scenario 500.

According to some implementations, DT-RS can include a time-domain sequence of complex values observed/defined at the output stage of a digital processing chain, including in-phase/real and quadrature/imaginary components defined together or separately via separate sequences. According to some implementations, DT-RS can include a sequence of time-domain complex values generated by a digital processing chain and observed/defined at the input of a DAC.

According to some implementations, DT-RS timing can be defined and/or specified in different ways. For instance, sequence of complex values associated with a DT-RS can be defined according to the timing of the output stage of a digital processor and/or according to the input/sample timing of the DACs (DACs of the real and imaginary parts following a shared or separate timing). In some implementations, the defined/configured/indicated sequence sample times of a DT-RS can be the same as the sampling time at which the output of a digital processor is generated and/or can be the same as the sampling time of the subsequent DACs from the output of the digital processing chains. In some other implementations, the defined/configured/indicated sequence and/or sequence sample times of a DT-RS may not be the same as the sampling time at which the output of a digital processor is generated and/or the sequence or sequence sampling time of the subsequent DACs from the output of the digital processing chains, and can represent an up or down-sampled version of the actual time-domain sequence and/or sequence sampling rate. For instance, a DT-RS can be defined for the first and/or second radio node with sample timing of half of the first radio node's time-domain sampling rate. As such, transmission of DT-RS (e.g., according to a configured/indicated DT-Rs parameters by the configuration entity or by the first radio node) by the first radio node includes an up-sampling stage at the first radio node of the configured/indicated DT-RS sequence and sequence timing. In one such example, the up-sampling stage includes up-sampling of the transmission symbol sequence by factor of 2 and copying the value original value into both up-sampled copies, e.g.,

$$\{ {T}_{1} , {T}_{2} , ⋯ , {T}_{N} \} \to \{ {T}_{1} {T}_{1} , {T}_{2} , {T}_{2} , ⋯ , {T}_{N} {T}_{N} \}$$

wherein the sampling rate of the right-hand side sequence is half of the left-hand side.

According to some implementations, the values of the sequence corresponding to the DT-RS can be generated according to the supported discrete set of the subsequent DACs at the first radio node. In some such implementations, this includes the real part of the generated sequence values to be within the supported DAC steps for the real/in-phase part, the imaginary part of the generated sequence values to be within the supported DAC steps for the imaginary/quadrature part, or the complex sequence values to be within the supported complex steps by the equivalent complex DAC (e.g., a complex DAC corresponding to the combination of the DACs of the real and imaginary parts).

In some related implementations, a second radio node can be configured/indicated for reception of the transmitted DT-RS by the first radio node, and thereby performing an indicated/configured measurement and/or reporting an indicated/configured measurement quantity, where an indication/configuration includes parameters describing the transmitted DT-RS by the first node (e.g., DT-RS definition in the time domain of the first radio node including the sampling rate and sequence value) and one or more of measurement quantities to be measured and/or reported.

According to some implementations, DT-RS can be defined using different parameters. For instance, the definition/configuration of a DT-RS (for the first and/or the second radio node) includes one or more of start/end time (e.g., sample number or time/time stamp corresponding to the first/last sample associated with a DT-RS), sampling rate/time (a sampling rate and/or sampling time at which the DT-RS sequence values are mapped to the transmission signal samples at the output stage of the digital processor or the input stage of a DAC), sequence of complex values (e.g., a sequence ID of a known/indicated complex random sequence generated according to the Gold random sequence as described in [3GPP TS 38.211] with an indicated initializer sequence) corresponding to the transmission samples at the sample times of the DT-RS, scalar amplification to be applied to the sequence values, etc. In some implementations, the value of the sampling rate/time of the first and/or second radio node can be indicated/reported implicitly to the configuration entity and/or transmitter and/or receiver of a DT-RS, e.g., via indication of one or more of the NFFT value, subcarrier spacing (SCS), of the first, second radio node.

In some implementations, the time-domain sampling rate of a DT-RS of the first radio node and/or the second radio node can be assumed/determined at the configuration entity according to a default baseband time-domain sampling rate of the first radio node and/or second radio node (e.g., determined according to the 1/{NFFT×Δf} of the configured BWP associated to the transmission and/or reception of the radio node). In some such implementations, the determination/assumption can be done responsive to the absence of an explicit indication by the first radio node and/or second radio node regarding the node's baseband sampling rate. In some implementations, the explicit indication can be done when the sampling rate of the first radio node and/or second radio node is different than a default sampling rate, e.g., according to the 1/{NFFT×Δf} of a carrier or a configured BWP associated with transmission by the first radio node and/or reception by the second radio node. In some other implementations, the baseband sampling rate (or, in some implementations, a supported baseband sampling rate as a down-sampled rate of the actual radio time-domain sampling rate for transmission and/or reception) of the first radio node and/or second radio node for transmission and/or reception can be indicated to the configuration entity (and/or the second radio node), e.g., as a capability information/feature. In some such implementations, the time domain sampling rate of the DT-RS and/or the first radio node and/or the second radio node can be assumed by the configuration entity and/or the second radio node according to the indicated capability information.

In some such implementations, the sampling rate of a configured DT-RS may not be explicitly indicated (e.g., by the configuration entity to the first radio node and/or second radio node for configuration of a DT-RS or by the first radio node and/or second radio node to the configuration entity as capability information exchange), and the sampling rate of an indicated DT-RS can be assumed by the radio node according to the time-domain sampling time/rate of the radio node. In some such implementations, the second radio node may assume the sampling rate according to its baseband time-domain sampling rate (e.g., according to the configured carrier or BWP bandwidth and potentially an indicated ratio/up sampling factor). In some implementations, the first radio node may assume the sampling rate according to its baseband time-domain sampling rate or the sampling rate of the digital time-domain output or the DAC sampling rate.

In some implementations, the sampling rate of a DT-RS and/or of a radio node (e.g., first radio node and/or second radio node) can be indicated (e.g., by the configuration entity, the first radio node and/or second radio node to the configuration entity, the first radio node and/or second radio node), e.g., when the DT-RS sampling rate is determined to be different from a default/assumed sampling rate of the radio node via one or more of: (1) an up-sampling/down-sampling ratio (for sampling rate of the DT-RS and/or first radio node and/or second radio node transmission or reception) of an assumed/default baseband sampling rate, e.g., an up-sampling rate R of a default rate computed as the 1/{NFFT×Δf} of a link associated with transmission or reception of a radio node; (2) absolute sampling rate of the first radio node and/or second radio node, e.g., a ratio of the basic time unit of the system Tₛ, T_{c} for the NR/LTE systems; and/or (3) according to a previously indicated sampling rate of a radio node or of or an RS (a previously indicated DT-RS).

In some implementations, an indicated/exchanged (e.g., between one or more of a first radio node, second radio node, configuration entity) time-domain sequence of a DT-RS and/or sampling rate of a DT-RS of the first and/or second radio node is not the same as the actual radio sampling rate of the first radio node or DT-RS. For instance, the exchanged time domain sequence and/or sampling rate may include an up-sampling stage prior to transmission at the first radio node of the sequence generated by the DT-RS configuration parameters. In some examples, the assumed baseband sampling rate of the second radio node can be different from the configured/indicated DT-RS sampling rate. For instance, as the second radio node, UE sampling rate can be adjusted to the supported BWP/processing bandwidth, whereas the sampling rate of the gNB as the first radio node can be adjusted to the full transmission band. In some such implementations, the second radio node adjusts the received baseband signal to the indicated DT-RS sampling rate prior to further processing of the received DT-RS for measurements. In some implementations, one or more of the parameters describing a first DT-RS can be defined via indication of a second RS/DT-RS. In one example, the sampling rate and/or scaling ratio of a first DT-RS can be indicated via a relation to a previously defined/indicated second RS (e.g., DT-RS).

In some implementations, the DT-RS definition includes a common set of assumptions on one or more of the DT-RS generation parameters (e.g., sequence type sequence parameter values, sampling rate, scaling value, etc.) for the DT-RS of UL transmission, DL transmission, SL transmission, or TRP-TRP transmission directions. For instance, TRP-TRP transmission directions can occur when a signal transmitted by one TRP is expected to be received by second TRP and perform measurements on the received signal associated with the TRP-TRP transmission and reception/measurement. As such, the configuration of a DT-RS can be assumed to include assumed features/parameters which are specific to the transmission direction, e.g., the DL DT-RS, UL DT-RS, SL DT-RS, TRP2TRP DT-RS.

In one example, the DL DT-RS can be assumed to be generated according to a Gold sequence and sampling time period according to the sampling time of the first radio as a UE, whereas the initializing sequence for generation of the DT-RS can be defined/indicated as RS-specific value. In another example, an UL DT-RS can be defined via the sequence dₙ=β×e^{j{nk(n)π/2+π/4}} with the sample timing of the n-th sample defined according to the UL frame timing of the first radio node UE and wherein β is determined/defined per UE and K(n)∈Z is a sequence of integer values and can be defined/determined per-DT-RS. In some examples, the timing (e.g., start/end time and/or time-domain sample period) of the DL DT-RS, UL DT-RS, SL DT-RS, TRP2TRP DT-RS can be assumed according to the frame timing assumed for the DL, UL, SL, TRP2TRP transmission directions at the first radio node and/or second radio node.

In some implementations, the capability information of a radio describing the LR behavior can be indicated/reported to the configuration entity. In some such implementations, the configuration of the first radio node and/or second radio node for transmission and/or reception/measurement of the DT-RS can be performed subsequent to/based on the received capability information of the first radio node. In some implementations, the capability information of the first radio node can include indication(s) of LR transmitter chain/DAC, supported (complex) quantization steps of the DAC or a subset thereof, supported scalar amplification β of the quantization steps, the supported maximum SNR/EVM with the consideration of the quantization distortion, the supported parameter set for a discrete sequence according to an assumed sequence-generation type (e.g., for a Zadoff-Chu (ZC)

sequence described in [3GPP TS 38.211] according to the set of parameters {β, u, v, α, σ, M_{ZC}}), or subsets and/or combinations thereof.

In some implementations, the first radio node indicates if one or more of indicated capability information (e.g., number of quantization steps) may be used to infer the supported Tx (maximum) SNR/EVM of the radio node. In some examples, the indicated capability of the first radio node of the supported discrete steps of the DAC may be used to infer the supported/maximum Tx SNR/EVM of the first radio node. In some alternate examples, the indicated supported steps of the DAC may not be used to infer the supported/maximum SNR/EVM of the radio node. For instance, the first radio node may not fully expose its DAC description but may only indicate a subset of the supported discrete steps. The first radio node, for example, may support 5 bit DAC but only indicate a supported discrete set including 4 steps. In one example, the indicated supported steps of the quantizer are subset of the supported DAC steps and/or the first radio node may apply non-linear precoder processing to reduce the quantization distortion, and hence an improved (maximum Tx) SNR or reduced EVM may be achieved as compared to the limit inferred from the indicated number of steps.

In some implementations, at least one or a subset of the parameters defining the DT-RS can be determined (e.g., autonomously) by the first radio node (e.g., upon explicit/implicit request of the configuration entity and/or upon indication of the other parameters by the configuration entity). The determined parameters can be assumed by the first radio node for generation of the DT-RS, indicated/reported to the configuration entity and/or the second radio node, or a combination thereof. In some such examples, the parameters can include at least scaling of the quantized steps (e.g., β which is determined according to the amplitude of the DAC steps of the first radio node) and/or the time-domain sampling rate for generation of the DT-RS. In some examples, the determined parameters can be indicated/reported dynamically upon configuration of the RS or as a capability information indication to the configuration entity, or not reported/indicated (e.g. where the receiver node blindly detects the assumed parameters).

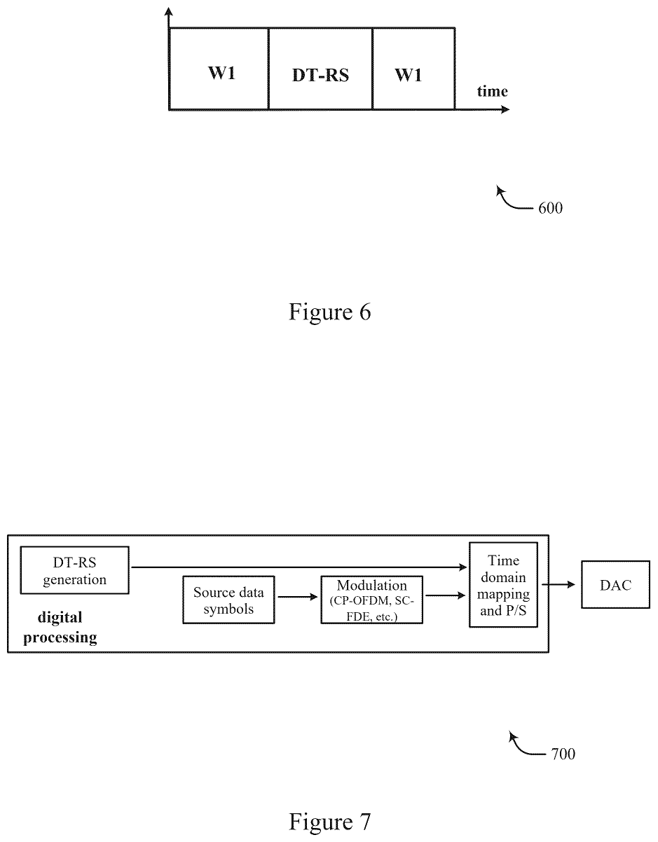

FIG. 6 illustrates an example 600 for radio node transmission in accordance with aspects of the present disclosure. In the example 600, the transmission of the data/control information of a physical channel by the radio node can be performed with a waveform type/parameter represented with W1, e.g., CP-OFDM waveform type with parameters defining values for the CP duration, SCS/Mu, etc. Further, in the example 600, the DT-RS is defined in the time-domain pre-DAC stage and TDM-ed with the other signals containing data/control information defined with an alternate waveform parameter described as W1.

In some implementations, DT-RS can be defined/indicated as a configured RS (e.g., as a known RS) plus an indication of a high Tx SNR or low quantization distortion. For instance, configuration of a DT-RS transmission and/or reception (for the first and/or second radio nodes) can include indication of one or more of transmission from an LR device (including an LR DAC), transmission of an LR transmitter with a high (maximum Tx) SNR or low EVM or low-quantization distortion condition, association with another RS/transmission with a high (maximum Tx) SNR or low-EVM condition. In some such implementations, transmission of a configured RS can be interpreted to be a DT-RS by the second radio node upon indication of one or more of the LR property, a high (maximum Tx) SNR condition, a low EVM condition, a high (maximum Tx) SNR condition, a low EVM condition associated to the first transmission, etc. In some implementations, a transmitter node of a configured first signal for reception at the second radio node is interpreted to be of a LR transmitter node by the second radio upon indication that the first signal can be associated with one or more of an LR property, a high (maximum Tx) SNR condition, a low EVM condition, a high (maximum Tx) SNR condition, a low EVM condition, etc.

In some implementations, the DT-RS can be indicated to be related to a second transmission via a QCL relation (e.g., sharing the same transmission condition, beam/antenna port, etc.) with the second transmission. In some implementations, a new relation or association type is defined for transmission of a DT-RS and a second transmission from the first radio, where the second transmission may include, for example, a second RS or transmission of a physical data/control channel where transmission of DT-RS can be used for channel equalization at the receiver/second radio. The new relation/association type can include an indication of one or more of (1) an expected higher quantization distortion or increased EVM/Tx impairments (e.g., according to an indicated impairments increase level) at the second transmission; (2) the association/QCL relation being defined assuming zero/low quantization distortion for the DT-RS transmission (which may not be true during the second transmission); and/or (3) the association/relation being defined assuming zero transmitter noise/impairments or zero (or an indicated equal) EVM at the transmitter for both transmissions.

In one such example, DT-RS can be used at the second radio node for purpose of equalization of the channel for transmission of data/control information using the same beam/antenna port as the DT-RS. Due to the discreteness of the DT-RS at the supported DAC steps, the quantization distortion may be negligible during transmission of the DT-RS, however, the Tx quantization distortion can impact the reception of the second radio node during the second transmission of the data/control information. Hence, the second radio node can be indicated that the second transmission is associated with the DT-RS transmission condition when assuming a high (maximum Tx) SNR/low EVM or no quantization distortion during the second transmission. In some other implementations the second radio node is indicated that the first transmission (of the DT-RS) is associated with the second transmission parameters where the Tx impairments/quantization distortions of the second transmission are not present for the first transmission.

In some implementations, the second radio node is configured to perform measurement and/or to report the performed measurement based on the received configured DT-RS by the first radio node. Examples of such measurement and/or reporting parameters include CSI measurement of reference signal received power (RSRP), reference signal received quality (RSRQ), rank indicator (RI), channel quality indicator (CQI), of one or more indicated/determined paths, precoder/equalizer matrix, measurement of the received power/energy, reference signal received path power (RSRPP), angle, time, doppler shift of the perceived channel or one or more indicated/determined paths associated with a line of sight (LOS) condition, to a target reflection, or combinations thereof.

In some implementations, measurement reports are indicated to be generated only from the RSs with low-distortion conditions, DT-RS, etc. For instance, when a second radio node is configured with reception of plurality of transmissions from the first radio node (with first radio node being an LR radio), and further the second radio node is configured to perform reporting of measured quantities (e.g., associated with sensing, positioning, CSI measurements such as ToA, time, angle, doppler estimation, etc.), the second radio node can be further indicated to generate the reporting measurement quantities only based on the transmissions indicated with one or more of a low EVM, high (maximum Tx) SNR, low Tx quantization distortion condition, indicated as being DT-RS transmissions, etc.

In some implementations, transmission from the second radio node include transmission of DT-RS and/or transmission of the modulated data signal sequence according to a time domain or a single-carrier waveform. In some examples, the information bits/symbols to be transmitted by the second radio node are modulated to the time-domain sequence Cₙ such that values of the complex sequence Cₙ correspond to the (1) modulated constellation points containing the information bits, e.g., wherein the constellation points may be generated according to the Binary Phase Shift Keying (BPSK), 4QAM, according to the supported complex discrete points of the DAC; (2) an unsampled version of the constellation points; (3) digital-filtered version of a sequence generated based on the constellation points, e.g., wherein the digital filtering has only one non-zero tap and restricted to the values (e.g., 0, 1, −1, $e\hat{ }{j\pi/2} $, etc.) which keep the generated constellation points within the supported discrete complex values of the DAC.

Thus, in implementations the data bits can be modulated into a time-domain waveform via a sequence of constellation points generated according to the discrete DAC steps. Further, modulation of data can include an oversampling and/or digital filtering stage where the digital filtering contains maximum one non-zero tap and the value of the non-zero tap is selected within a set including at least one or more of {e\hat{ }{j2\pi/m}} with m=1 . . . . M and M associated with the number of the bits or supported discrete steps of the DAC.

In some implementations, the configurations/indications (e.g., configuration of DT-RS parameters, of measurements and/or reporting to be performed based on reception of a configured DT-RS), indications, and/or reporting information elements between a sensing Tx/Rx node and the SensMF or a subset thereof are exchanged between the radio configuration entity and the first or second radio node. Such information, for instance, can be exchanged between the first and second radio node via the UL, DL or SL physical data and/or control channels defined within the communication network (e.g., NR physical broadcast channel (PBCH), PDSCH, physical downlink control channel (PDCCH), PUSCH, PUCCH, physical sidelink broadcast channel (PSBCH), physical sidelink control channel (PSCCH), physical sidelink shared channel (PSSCH), via a higher layer (medium access control (MAC)-control element (CE) or radio resource control (RRC)) signaling, etc.) and/or via an interface between the SF (a sensing management/controller entity located in RAN or in core network) or LMF (located in CN or in RAN) and the radio configuration entity and/or the first radio node and/or the second radio node.

FIG. 7 illustrates an example implementation 700 for generating DT-RS in accordance with aspects of the present disclosure. In this example, DT-RS can be generated separately from the data modulation process and then later multiplexed in time domain with the modulated time-domain signal. For instance, the DT-RS may be generated separately from the modulation process of the source data/control information which are assigned with dedicated one or more of symbols, slots, subframes (e.g., PDSCH/PUSCH or other physical channels generated according to a CP-OFDM, DFT-s-OFDM or a single carrier (SC)-frequency domain equalization (FDE) waveform type and a configured numerology/waveform-defining parameters such as SCS, CP overhead, Number of Fast Fourier Transform points (NFFT) size, etc.). The DT-RS may then be multiplexed in time domain with the outcome of the modulated time-domain signal of the data/control information at a dedicated/configured time-occasions for the DT-RS. The outcome stage of “time-domain mapping and P/S” maps the DT-RS to the assigned time-domain occasions according to the configured DT-RS parameters (e.g., the start/end time and sampling rate, etc.).

As further detailed below, DT-RS can TDM with a second transmission, can be assigned with one or more indicated symbols, and can be assigned with dedicated symbols within slot, with symbol features dedicated for DT-RS transmission and part of a new slot/subframe format.

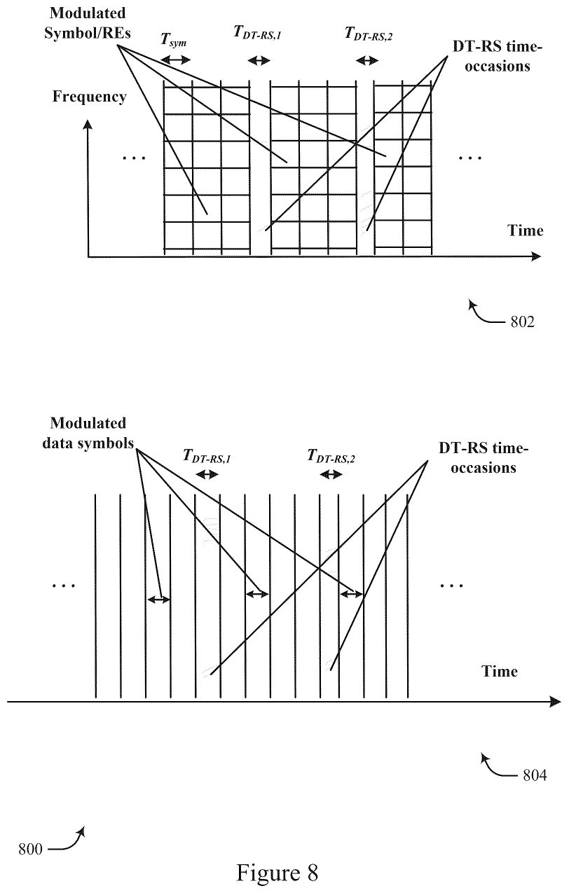

FIG. 8 illustrates example scenarios 800 for TDM of DT-RS in accordance with aspects of the present disclosure. In the example scenarios 800 the DT-RS occasions are allocated outside of the data-containing modulated symbols (e.g., as a configured allocated time between symbols). In a scenario 802, the DT-RS occasions are multiplexed between the data-containing symbols of a multi-carrier modulation. In a scenario 804, the DT-RS occasions are multiplexed between the data-containing symbols carrying modulated data via a time-domain/single carrier modulation (e.g., SC-FDE or DFT-s-OFDM, SC-OFDM, UW-FDMA).

In some implementations, T_{sym}=T_{TD-RS,1}=T_{TD-RS,2}. In some other implementations, the duration of each RS-TD symbol, and/or the modulated (data-containing) symbol may be different. In some implementations, DT-RS occasions are defined as part of the slot or sub-frame format, wherein dedicated time symbols are assigned for the DT-RS transmission. In some such implementations, the slot or a subframe format may include different symbol types, e.g., symbols for one or more of UL transmission, DL transmission direction, SL transmission direction, DL DT-RS-dedicated transmission, UL DT-RS-dedicated transmission, SL DT-RS-dedicated transmission, or flexible symbols which can be flexibly configured to carry said transmission type.

In some implementations, DT-RS symbols may have different parameters and/or characteristics than other non-DT-RS symbols. For instance, the slot or subframe duration containing the DT-RS symbol(s) is different (e.g., longer, in order to embed the DT-RS transmission overhead) from the slot duration with no DT-RS symbol(s) transmission. Further, the new slot/subframe duration can be assumed upon determination that the DT-RS symbol(s) transmission is provisioned within the slot/subframe format. In some implementations, the symbols containing DT-RS and/or the slot/subframe format containing the DT-RS symbols can be associated with a different parameters or numerology/numerology definition, e.g., different values for one or more of symbol duration, sampling rate, CP duration/overhead, etc. In some examples, the symbol containing DT-RS can be associated with a shorter symbol duration than the symbol containing modulated data, and may include no-CP or a similar or bigger CP length/overhead.

In some implementations, a slot/subframe format for a slot/subframe including a DT-RS symbol can be indicated via an index from a codebook X, where the codebook X includes different slot/subframe formats defining symbol types/parameters of each symbol within the slot/subframe. An example of such DT-RS loaded slot format codebook is given in Table 4, below. The symbols associated with F-DT-RS are the symbols assigned for DT-RS transmission, however, the transmission direction (of UL, DL, SL) may be selected flexibly. In some implementations, the flexible symbols may be assigned to any transmission direction, however, may not be assigned to transmission of a DT-RS symbol. In some other implementations, the flexible symbols may be assigned as a DT-RS for a dynamically configured transmission direction (e.g., a F symbol may be assigned as an UL DT-RS symbol via a dynamic DL control information (DCI) indication to a UE). In some implementations, the index defining slot format is interpreted via the codebook X, upon a prior indication or determination of presence of dedicated DT-RS symbols within the slot and is interpreted via another codebook for slot format definition upon absence of such determination/indication.

TABLE 4
Illustration of slot format indicator via an index from the X codebook.

| | Symbol number in a slot | | | | | | | | | | | | | |
|---|---|---|---|---|---|---|---|---|---|---|---|---|---|---|
| Format | 0 | 1 | 2 | 3 | 4 | 5 | 6 | 7 | 8 | 9 | 10 | 11 | 12 | 13 |
| 0 | DL | D | D | D | DL | D | D | DL | D | DL | D | D | DL | D |
| | DT-RS | | | | DT-RS | | | DT-RS | | DT-RS | | | DT-RS | |
| 1 | UL | U | U | U | UL | U | U | U | U | U | U | U | U | U |
| | DT-RS | | | | DT-RS | | | | | | | | | |
| 2 | F- | F | F | F | F- | F | F | F- | F | F- | F | F | F | F |
| | DT-RS | | | | DT-RS | | | DT-RS | | DT-RS | | | | |

| . . . | . . . | | | | | | | | | | | | | | | | |
|---|---|---|---|---|---|---|---|---|---|---|---|---|---|---|---|---|---|
| | Symbol number in a slot | | | | | | | | | | | | | | | | |
| Format | 0 | 1 | 2 | 3 | 4 | 5 | 6 | 7 | 8 | 9 | 10 | 11 | 12 | 13 | 14 | 15 | 16 |
| N | DL | D | DL | D | DL | D | D | DL | D | DL | D | D | DL | D | D | DL | D |
| | DT-RS | | DT-RS | | DT-RS | | | DT-RS | | DT-RS | | | DT-RS | | | DT-RS | |
| N + 1 | UL | U | UL | U | UL | U | U | UL | U | DL | D | D | DL | D | | DL | D |
| | DT-RS | | DT-RS | | DT-RS | | | DT-RS | | DT-RS | | | DT-RS | | | DT-RS | |

| | |
|---|---|
| . . . | . . . |

In some implementations, the codebook X can be specific to presence of DT-RS transmission in a particular direction wherein no DT-RS transmission is provisioned for the other transmission directions. In one such example, transmission of DT-RS may be provisioned only in UL transmission and/or SL transmission direction for slot format. In some other examples, the DT-RS transmission may be only provisioned for DL transmission direction for a slot format. In some examples, presence of DT-RS transmission symbols at a particular direction can be associated/indicated based on the LR feature of a transmission radio node. In some such implementations, the slot format can be assumed according to the received index as well as indication of the DT-RS transmission which defines the assumed codebook by which the index can be interpreted.

In some implementations, when dedicated DT-RS symbols are present, slot symbol number may vary. For instance, some of the slot formats including DT-RS include different number of symbols and/or symbol duration/timing, e.g., one row of Table 4 may include 17 symbols including DT-RS symbols with different symbol duration compared to that of the modulated data/containing symbols. In some implementations, a slot/subframe format can be assumed based on indication of an LR transmission condition as well as an index from the codebook X. In some implementations, parameters of a DT-RS symbol, at least in part, can be defined via an index from a codebook Y, where the codebook comprising different possible combinations for values of the DT-RS related symbol parameters (e.g., one or more of symbol duration, sampling rate, CP duration/overhead, etc.). In some implementations, the slot/subframe format, the DT-RS symbol occasions, and parameters describing DT-RS symbols, or a combination thereof, can be indicated (e.g., to the first and/or second radio node by the configuration entity) dynamically (e.g. via a DCI), semi-statistically, or periodically (e.g., via RRC configuration message).

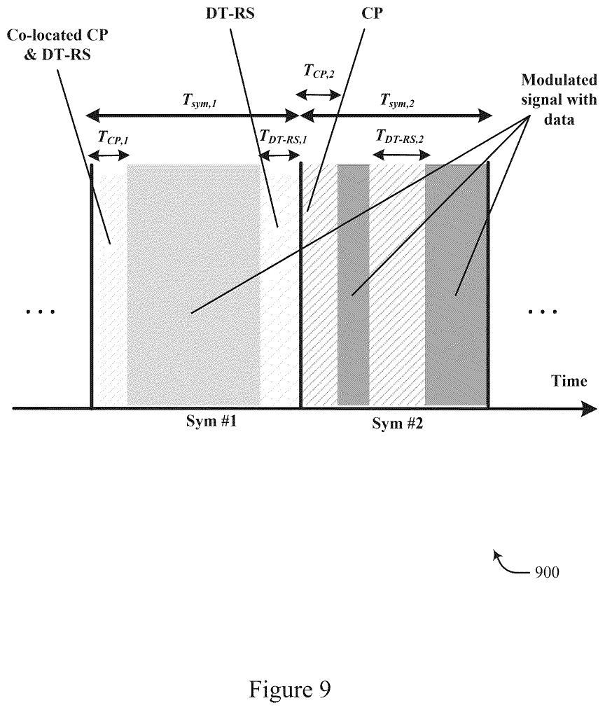

FIG. 9 illustrates an example 900 for DT-RS generation in accordance with aspects of the present disclosure. In this example, DT-RS can be generated (e.g., TDM) as part of a time-domain symbol. For instance, in the example 900, DT-RS is generated within (as part of) one or more configured time-domain symbols utilizing at least in part a shared modulation process for the modulated symbols containing data/control information. Further, DT-RS time allocation is depicted where DT-RS is part of a time-domain symbol. The first depicted symbol (Sym #1) illustrates a case where the TD-RS co-indices, fully or at least in part, with the part of the symbol time window copied into the CP. The second depicted symbol (Sym #2) illustrates a case where the TD-RS is not part of the symbol time copied as a CP. In some implementations, the DT-RS is generated as part of a symbol which is modulated according to one of the SC-FDE, CP-OFDM, SC-FDMA, DFT-s-OFDM, Unique-Word Orthogonal Frequency-Division Multiplexing (UW-OFDM) waveform. In one example, the DT-RS is generated as part of a modulated CP-OFDM symbol. In some examples, generation of DT-RS contains NDT-RS samples at a configured/indicated timing within the symbol which is defined by a start time-domain sample and the duration, or the last time-domain sample associated with the DT-RS.

As discussed in more detail below, in implementations DT-RS can be TDM with a second transmission (of another DT-RS/RS, a physical channel etc.) within a shared symbol with a second transmission. Further, DT-RS transmission at a symbol including an IFFT stage can include shaping dedicated REs for time-domain shaping. DT-RS transmission of a symbol including an IFFT block can include adjusted IFFT length to the time-domain TD-RS duration and multiplexing of the DT-RS at the post-IFFT stage. Further, DT-RS can be TDM (inside a symbol) with the modulated samples at the time-samples corresponding to the CP of the signal at the pre-CP insertion stage.

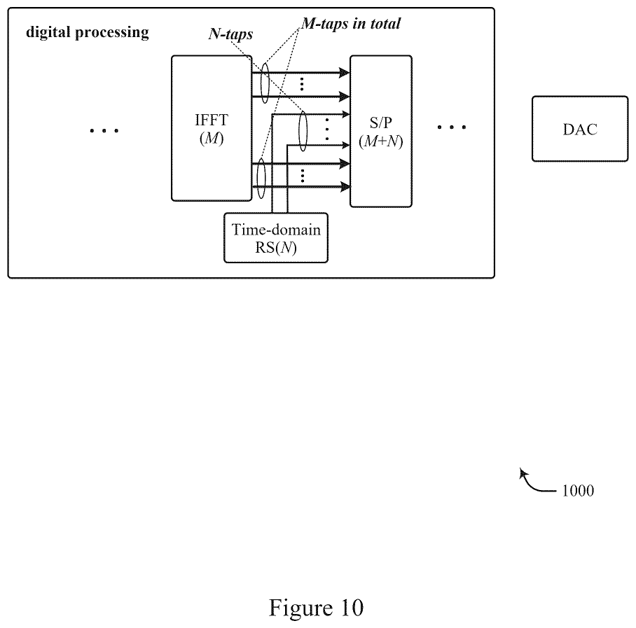

FIG. 10 illustrates an example 1000 for DT-RS generation in accordance with aspects of the present disclosure. In this example, DT-RS can be generated as part of a time-domain symbol by adjusting the IFFT size and mapping of the output samples. In some implementations for the generation of time-domain RS samples (e.g., DT-RS) as part of a modulated symbol including an IFFT/IDFT stage, the DT-RS/time-domain RS generation can be performed as part of a time-domain symbol by adjusting the IFFT size and mapping of the output samples of the IFFT block, such as illustrated in the example 1000. In some implementations, the IFFT size may be adjusted based on the symbol size and the number of the samples determined to carry the time-domain RS. The sample position of the inserted time-domain RS may be aligned with the start or end of the IFFT (M) output samples or aligned with an indicated reference (as the starting sample of the N sampled belonging to the inserted time-domain RS).

In some implementations, the IFFT stage is utilized as subsequent to a prior DFT/FFT stage (e.g., for spreading of the modulated data points) or a prior FFT/DFT or IFFT/IDFT stage applied in the signal sample array of a different signal dimension (e.g., array of signal values stacked from instances of signal at different symbols and/or at different antenna/antenna port/spatial layer). In some examples, a subsequent CP insertion step is present subsequent to the S/P block. In some other examples, one or multiple inserted time-domain RSs are placed such that they generate (with or without a subsequent CP-insertion step) a cyclic structure, by having a same sequence at the beginning and end of the symbol or S/P block.

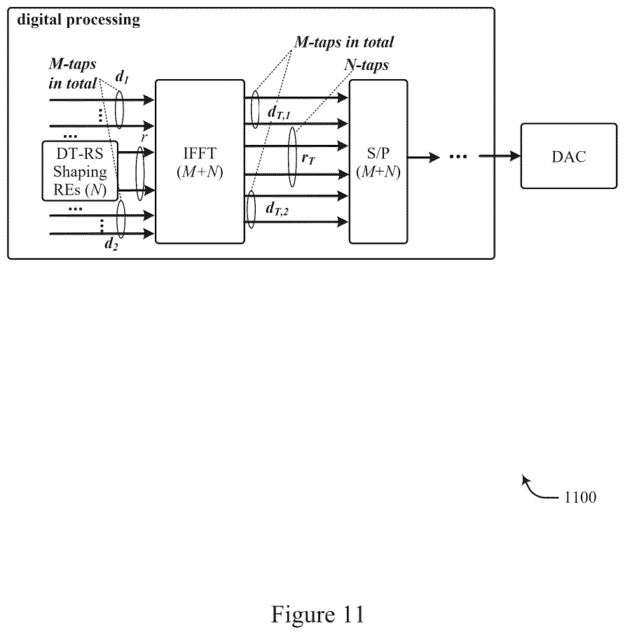

FIG. 11 illustrates an example 1100 for DT-RS generation in accordance with aspects of the present disclosure. In this example, DT-RS can be generated at expected locations of a post-IFFT block, utilizing a time-domain/DT-RS shaping block at some of the REs/resource units prior to the IFFT stage. In some implementations, the configuration of the sub-symbol time-domain RS (such as the described DT-RS) generation where the transmission processing includes an IFFT/IDFT block (e.g., with the CP-OFDM modulation) can include one or more of start time-domain sample and the last time-domain sample, number of samples associated with the DT-RS, DT-RS values associated with the time-samples, and DT-RS (or time-domain)-shaping REs.

The REs may include REs which may be utilized by the first radio node for generating the DT-RS at the requested time samples. For instance, the REs can include REs whose complex transmission values are determined by the first radio node such that, given the other REs of the same symbol containing modulated data REs, generate the requested DT-RS values at the associated time-domain samples of the DT-RS. In some examples, this is implemented according to the processing blocks depicted in the example 1000. In some implementations, the REs are further indicated to the second or a third radio node as being REs containing transmission but no information. In some implementations, the sub-symbol DT-RS is generated only at the part of the symbol associated with the CP segment.

In some implementation related to the depicted processing in the example 1000 (e.g., for DT-RS shaping REs), the IFFT matrix and the input-output relation may be described as

$$[ \begin{matrix}{d}_{T , 1} \\ {r}_{T} \\ {d}_{T , 2}\end{matrix} ] = {\underbrace{[ \begin{matrix}{F}_{11} & {F}_{12} & {F}_{13} \\ {F}_{21} & {F}_{22} & {F}_{23} \\ {F}_{31} & {F}_{32} & {F}_{33}\end{matrix} ]}}_{IFFT} [ \begin{matrix}{d}_{1} \\ r \\ {d}_{2}\end{matrix} ] , {r}_{T} = {F}_{22} r + {F}_{21} {d}_{1} + {F}_{23} {d}_{2}$$

where r_{T} denotes the intended signal to be shaped in the time-domain and r represents the values of the TD-RS-shaping REs prior to the IFFT stage. As such, in one implementation, the values of r are chosen according to

$${r}^{⋆} = {F}_{22}^{- 1} ( {r}_{T} - {F}_{21} {d}_{1} - {F}_{23} {d}_{2} )$$

in order to generate r_{T} according to the desired value and time-domain position.

The above example for sub-symbol DT-RS generation within the CP-OFDM waveform is not restricted to this waveform and can be utilized (e.g., by assigning the resource units used in the modulation process to transmission adjustment corresponding to the configured DT-RS behavior) for generation of the DT-RS as part of a symbol containing a multi-carrier transmission. In some implementations, when the intended time-domain sequence (not necessarily limited to DT-RS type sequence by any sequence in time domain) shares the same timing as the CP of the symbol, the same procedure can be used to generate the CP as desired. In some examples, the CP-shaping REs (similar to the described above for generation of the DT-RS) are used to shape the time-domain symbol properties. In some implementations (e.g., as illustrated in the example 900), the depicted first and second symbol are any symbols within a slot/frame which are exemplified with such numbering. In some implementations it holds one or more of T_{sym, 1}=T_{sym,2}, T_{TD-RS,1}=T_{TD-RS,2}, T_{CP,1}=T_{TD-RS,1}. In some implementations, any of the equalities may not hold, e.g., the T_{TD-RS,1} may be larger or smaller than the T_{CP,1}.

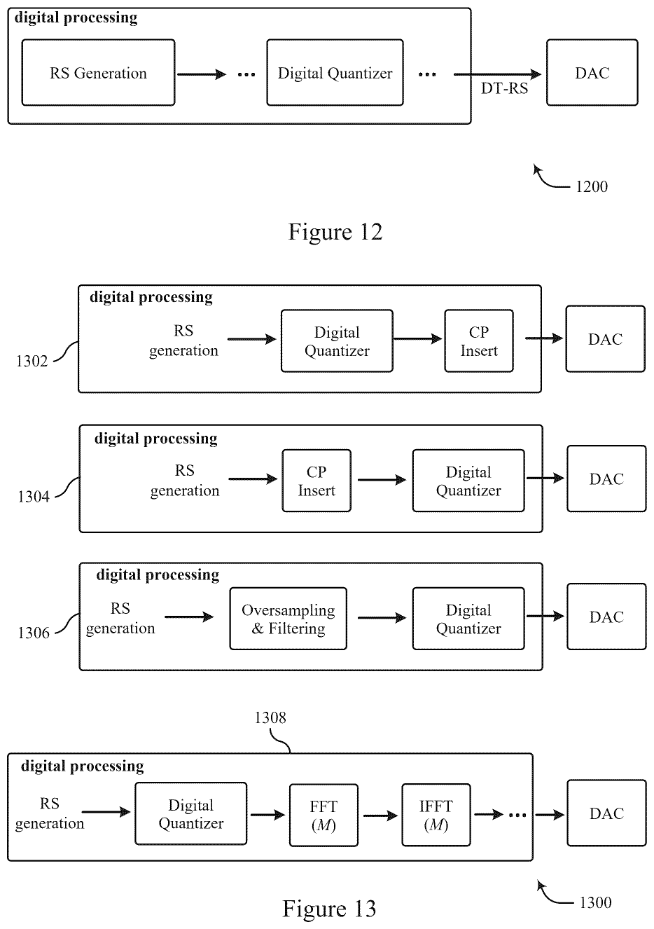

FIG. 12 illustrates an example 1200 for generation of DT-RS in accordance with aspects of the present disclosure. In this example, DT-RS can be generated as a time domain sequence of complex values at the input of the DAC with the assistance of a digital quantizer (DQ). In some implementations such as illustrated in the example 1200, generation of DT-RS is performed by utilizing a DQ, which performs (e.g., as part of the digital baseband processing inside a digital processor, e.g., a DSP, FPGA, etc.) one or more of a phase rotation, amplitude adjustment/scaling, quantization operation by projecting the value of an input sample to the DQ into a configured set of supported discrete values of the DQ, etc. The output of the DQ is then utilized to generate the time-domain output of the digital processor and/or the time-domain signal input to the DAC. As such, the DQ can adjust the input complex valued of the DAC such that the quantization distortion is reduced/eliminated. In an at least one example, instead of using a full DT-RS definition, a known RS can be used together with a configured DQ step.

FIG. 13 illustrates examples 1300 for generation of DT-RS in accordance with aspects of the present disclosure. In these examples, DT-RS can be generated as a time domain sequence of complex values at the input of the DAC with the help of a digital quantizer and utilizing another/known RS generation. For instance, DT-RS can be generated utilizing a digital quantization step, where the digital quantization step includes supported quantization steps. Further, a DQ can be utilized for generation of the DT-RS at various stages such as post IFFT stage and prior to CP insertion, post IFFT stage and after CP insertion, after an up sampling and filtering stage, etc.

According to some implementations such as depicted in an example 1302, the DT-RS is generated at the output stage of the digital processor where DQ is applied on an RS generated in the time domain prior to the CP insertion for any of the waveforms including a CP insertion step. The RS generation may include any of the known RS generation procedures (e.g., NR DL PRS, UL SRS, etc.) according to the modulation waveform. One example is generation of a PRS in the DL within a CP-OFDM waveform for a symbol prior to addition of the CP. According to this example, the DQ projects the complex values of the generated RS into the complex discrete set defined for the DQ. As such, the input to the DAC is expected to be within the supported discrete values of the DAC (to eliminate the quantization distortion effect), utilizing a shared procedure for RS generation. According to some alternate implementation depicted in an example 1304, the DQ may be applied after the CP insertion step prior to the output stage of the digital processor.

According to some implementations depicted as in an example 1306, the DT-RS is generated at the output stage of the digital processor where the DQ is applied after an oversampling and/or digital filtering stage on an initially generated RS.

In some implementations (which are not restricted to use of DQ, and can be used for any implementation of the DT-RS), when an oversampling and filtering stage is present in the modulation process of a symbol containing DT-RS, the oversampling and filtering stage used for generation of the DT-RS may be a different stage as a stage used in the symbols with no DT-RS transmission. In one such example, the oversampling and filtering stage includes filtering coefficients which, when applied to a generated DT-RS, the respective output complex values fall within the supported discrete set. In some examples, the filtering of the oversampling and filtering stage (after the oversampling/zero-padding) may include copying the values of non-zero samples of the oversampled sequence into the zero-sample values, utilizing potential multiplication coefficients limited to all or subset of

$$\{ - 1 , 0 , 1 , \frac{1}{\sqrt{2}} ( 1 + 1 j ) , \frac{1}{\sqrt{2}} ( 1 - 1 j ) , \frac{1}{\sqrt{2}} ( - 1 + 1 j ) , \frac{1}{\sqrt{2}} ( - 1 - 1 j ) ) \}$$

in order to preserve the oversampled value sequence within the same discrete space as supported by the corresponding DAC.

In some implementations, the DT-RS is defined as the outcome of the signal generation according to a single carrier (e.g., SC-FDE waveform) where a RS with values within a subset supported by the DAC quantization steps are utilized as the input to the modulation process. In some other such implementation, a DQ is applied at the output of the modulation process subsequent to the single carrier signal generation. According to some implementations such as depicted in example 1308, the DT-RS is generated at the output stage of the digital processor where the DQ is applied on an RS generated in a time domain, and is later passed to the FFT stage. The outcome of the FFT stage is then utilized as the subsequent IFFT stage.

In some examples, the digital equalizer is defined with set of quantization steps which are equal to the supported quantization steps of the DAC. In some such examples, the information on supported DAC quantization steps are shared by the LR node with the second radio node or a configuration node. In some examples, the set of quantization steps of the digital quantizer is a subset of the supported quantization steps of the DAC. In one such example, the set of quantization steps of the digital quantizer is assumed by the first and the second node as an apriori-defined set (e.g., includes two steps (separately for real and imaginary parts)) and are defined as V*(1+1j, 1−1j, −1+1j,−1−1j), where V is the step size. In some other examples, the set of the quantization steps of the digital quantizer is determined by the first node and indicated to the second node or a configuration node. In some other implementations, the set of quantization steps of the digital quantizer is determined by the second node or a configuration node based on the capability indication of the first node (e.g., on the supported DAC quantization steps) and further indicated to the first radio node and/or second radio node.

In some implementations, the DT-RS sequence (e.g., the sequence of the values within the discrete set supported by the DAC input) is constructed via at least in part one or more gold sequence for each real and imaginary parts, where summation of separately generated binary gold sequences (in the real and imaginary parts) scaled with a scaling factor β are utilized to construct the discrete RS sequence and wherein β is the scaling factor and determined according to the a supported DAC step size.

In some examples, the sequence of the values within the discrete set supported by the DAC input is constructed via a ZC sequence as

$$β {r}_{u , v}^{( α , σ )}$$

(e.g., according to TS 38.211) where the parameters {β, u, v, α, σ, M_{ZC}} are defined such that the generated sequence falls within the supported discrete steps of the DAC. In some implementations, the supported combination of one or more of the parameters (e.g., sequence generation parameter(s)) are indicated by the first radio node as capability indication for generation/transmission of the DT-RS according to the supported discrete steps of the DAC and/or a known/indicated sequence generation procedure (e.g., according to the ZC sequence generation with length of less than 32).

In some implementations, the first radio node, responsive to being configured with RS parameters by the radio configuration entity, indicates suitability or unsuitability of the received RS configuration parameters according to its supported LR behavior (e.g., when the RS values are not within the supported discrete steps of the DAC). In some implementations, the second radio node suggests alternate RS parameters (one or more of the DT-RS parameters according to the first radio node capabilities).

In some implementations, one or more configured RS parameters (e.g., parameters defining a DT-RS or a DL PRS or an UL SRS) by the configuration entity for transmission of the first radio node are first adjusted by the first radio node prior to transmission. For instance, the first radio node can autonomously adjust one or more RS parameters with be within a discrete space. In some implementations, such adjustment step is indicated/requested/allowed to be performed by the first radio node by the configuration entity. In some implementations, the first radio node, upon determining adjusted parameters of the RS, transmits the configured RS according to the adjusted parameters. In some implementations, the first radio node, upon determining adjusted parameters of the RS, indicates/reports the adjusted RS parameters to the configuration entity and/or the second radio node. In some implementations, the adjustment and the RS parameters may include one or more of adjusting the sequence amplification factor β to match the supported discrete step size of the DAC, adjusting the sequence values with a phase rotation (e.g., multiplication of e^{jϕ}^{₀}), or a combination thereof.

In some examples, upon indication of an LR condition by the first radio node to the configuration entity, the configuration of the DT-RS for the first radio node is performed implicitly, e.g., including configuration of a known RS (e.g., a DL/SL-PRS, UL-SRS, not explicitly associated with a DT-RS feature). For instance, an implicit DT-RS configuration for Tx can be utilized via a known RS plus an implicit effect of the DAC quantization. As such, the known RS is transmitted by the first radio node according to the supported discrete structure of the DAC (e.g., quantized by the DAC according to the indicated DAC description by the first radio node to the configuration entity). As such, a DT-RS description/parameters can be assumed at the configuration entity or at the second radio node according to the combination of the known RS parameters and the discrete structure supported by the DAC.

In some implementations, the indication/configuration of a DT-RS for the second radio node (e.g., for performing measurements on the configured DT-RS) is performed implicitly. For instance, in such scenarios configuration of the DT-RS can include indication/configuration of a known RS (e.g., a DL/SL-PRS, UL-SRS, not explicitly associated with a DT-RS feature) combined with an indication (e.g., via absolute values or index from a codebook of different possible DAC configurations) of the supported set (or subset) of complex discrete values/steps of the transmitter DAC at the first radio node. As such, the transmitted RS signal is defined implicitly with the combination of the known RS and indication of the discrete/quantization structure. For instance, an implicit DT-RS Rx configuration can be utilized via a known RS plus an implicit effect of the Tx DAC quantization.

In some implementations, a relation/QCL is defined between a first signal (e.g., a configured signal for reception such as a DL-PRS) and a second signal (e.g., a previously indicated signal with a defined/indicated DAC description) such that the two signals share a related DAC quantization description. For instance, the DACs share the same number of quantization bits or same quantization steps or the quantization steps of the first signal being a subset of the quantization steps of the second signal, or vice-versa.

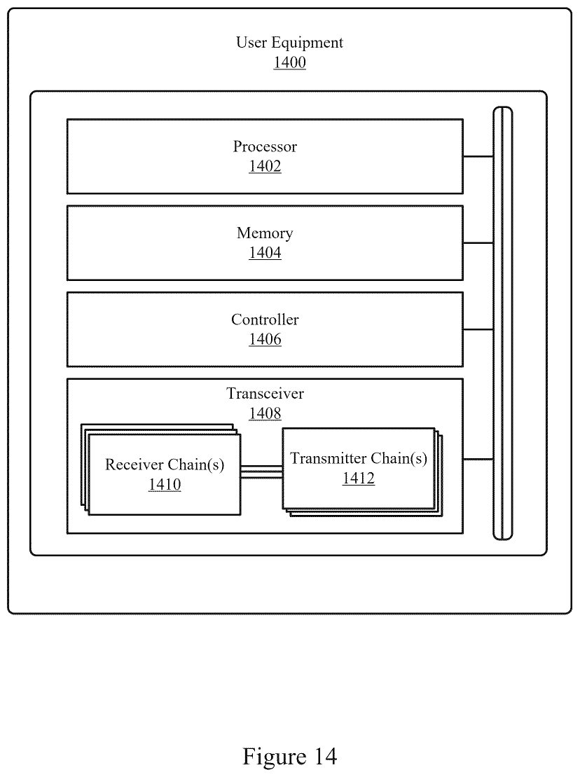

FIG. 14 illustrates an example of a UE 1400 in accordance with aspects of the present disclosure. The UE 1400 may include a processor 1402, a memory 1404, a controller 1406, and a transceiver 1408. The processor 1402, the memory 1404, the controller 1406, or the transceiver 1408, or various combinations thereof or various components thereof may be examples of means for performing various aspects of the present disclosure as described herein. These components may be coupled (e.g., operatively, communicatively, functionally, electronically, electrically) via one or more interfaces.

The processor 1402, the memory 1404, the controller 1406, or the transceiver 1408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1402 may include an intelligent hardware device (e.g., a general-purpose processor, a DSP, a CPU, an ASIC, an FPGA, or any combination thereof). In some implementations, the processor 1402 may be configured to operate the memory 1404. In some other implementations, the memory 1404 may be integrated into the processor 1402. The processor 1402 may be configured to execute computer-readable instructions stored in the memory 1404 to cause the UE 1400 to perform various functions of the present disclosure.

The memory 1404 may include volatile or non-volatile memory. The memory 1404 may store computer-readable, computer-executable code including instructions when executed by the processor 1402 cause the UE 1400 to perform various functions described herein. The code may be stored in a non-transitory computer-readable medium such as the memory 1404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1402 and the memory 1404 coupled with the processor 1402 may be configured to cause the UE 1400 to perform one or more of the functions described herein (e.g., executing, by the processor 1402, instructions stored in the memory 1404). For example, the processor 1402 may support wireless communication at the UE 1400 in accordance with examples as disclosed herein.

The UE 1400 may be configured to or operable to support a means for transmitting first capability information including one or more low-resolution transmit behaviors of the UE; receiving second configuration information for transmission of a RS; and transmitting, based at least in part on the second configuration information, one or more RSs.

Additionally, the UE 1400 may be configured to support any one or combination of where the one or more low-resolution transmit behaviors of the UE are associated with a low resolution DAC of the UE, and the RS includes a sequence of time-domain complex values; the first capability information includes capability information for the UE, the capability information including one or more of: a discrete set as a subset of one or more supported steps of one or more DACs of the UE; a first value equal to or smaller than a number of quantization states supported by the one or more DACs of the UE; a second value equal to or smaller than a number of quantization bits supported by the one or more DACs of the UE; or at least one supported sampling time of the one or more DACs of the UE; the second configuration information includes one or more of: a sequence of complex values defined in time-domain as an output of a digital baseband processor; a defined sequence of complex values defined in the time-domain as input of one or more DACs of the UE; one or more of a sampling time or a sampling rate associated with the defined sequence of complex values; a scaling value applied on the defined sequence of complex values; a phase rotation applied on the define complex sequence of complex values; a reference to one or more previous RSs; or different RS definitions for multiple different transmission directions; autonomously determining one or more RS parameters; one or more of: time division multiplexing (TDM) the one or more RSs with a second transmission; assigning the one or more RSs to one or more indicated symbols; or assigning the one or more RSs to one or more dedicated symbols within a slot, the one or more dedicated symbols including symbol features dedicated for RSs.

Additionally, the UE 1400 may be configured to support any one or combination of where a slot or a subframe that includes one or more RS symbols includes differing parameters or characteristics than a slot or a subframe that does not include one or more RS symbols; one or more of: one or more of RS symbol parameters, RS symbol slot format, or RS subframe format are indicated via reference to a codebook; or a codebook for RS is associated with one or more of a transmission direction or a low resolution feature of the UE; one or more of: the one or more RSs are TDM as part of a defined symbol; or the one or more RSs are TDM within a shared symbol with a second transmission; one or more of: transmission of the one or more RSs at a symbol including an IFFT stage includes shaping dedicated REs for time-domain shaping; or transmission of the one or more RSs at a symbol including an IFFT stage includes adjusting an IFFT length to a RS duration and multiplexing the one or more RSs at a post-IFFT stage; the one or more RSs are TDM within a symbol with modulated RS samples at time-samples corresponding to a CP of an associated signal at a pre-CP insertion stage.

Additionally, the UE 1400 may be configured to support any one or combination of generating the one or more RSs using a digital quantization step from one or more supported digital quantization steps of the UE; generating the one or more RSs using digital quantization at one or more of: after an IFFT stage and prior to CP insertion; after the IFFT stage and after CP insertion; after an upsampling and filtering stage; or after a RS generated in time domain (e.g., a time-domain signal of an RS generated according to a known waveform (e.g., a CP-OFDM or DFT-s-OFDM)); adjusting one or more parameters of the one or more RSs to be within a discrete space (e.g., a discrete set of values associated with a DAC) prior to transmission of the one or more RSs; transmitting an indication of the adjusted one or more parameters of the one or more RSs.

Additionally, or alternatively, the UE 1400 may support at least one memory (e.g., the memory 1404) and at least one processor (e.g., the processor 1402) coupled with the at least one memory and configured to cause the UE to transmit first capability information including one or more low-resolution transmit behaviors of the UE; receive second configuration information for transmission of a RS; and transmit, based at least in part on the second configuration information, one or more RSs.

Additionally, the UE 1400 may be configured to support any one or combination of where the one or more low-resolution transmit behaviors of the UE are associated with a low resolution DAC of the UE, and the RS includes a sequence of time-domain complex values; the first capability information includes capability information for the UE, the capability information including one or more of: a discrete set as a subset of one or more supported steps of one or more DACs of the UE; a first value equal to or smaller than a number of quantization states supported by the one or more DACs of the UE; a second value equal to or smaller than a number of quantization bits supported by the one or more DACs of the UE; or at least one supported sampling time of the one or more DACs of the UE; the second configuration information includes one or more of: a sequence of complex values defined in time-domain as an output of a digital baseband processor; a defined sequence of complex values defined in the time-domain as input of one or more DACs of the UE; one or more of a sampling time or a sampling rate associated with the defined sequence of complex values; a scaling value applied on the defined sequence of complex values; a phase rotation applied on the define complex sequence of complex values; a reference to one or more previous RSs; or different RS definitions for multiple different transmission directions.

Additionally, the UE 1400 may be configured to support any one or combination of where the at least one processor is configured to cause the UE to autonomously determine one or more RS parameters; the at least one processor is configured to cause the UE to one or more of: TDM the one or more RSs with a second transmission; assign the one or more RSs to one or more indicated symbols; or assign the one or more RSs to one or more dedicated symbols within a slot, the one or more dedicated symbols including symbol features dedicated for RSs; a slot or a subframe that includes one or more RS symbols includes differing parameters or characteristics than a slot or a subframe that does not include one or more RS symbols; one or more of: one or more of RS symbol parameters, RS symbol slot format, or RS subframe format are indicated via reference to a codebook; or a codebook for RS is associated with one or more of a transmission direction or a low resolution feature of the UE; one or more of: the one or more RSs are TDM as part of a defined symbol; or the one or more RSs are TDM within a shared symbol with a second transmission; one or more of: transmission of the one or more RSs at a symbol including an IFFT stage includes shaping dedicated REs for time-domain shaping; or transmission of the one or more RSs at a symbol including an IFFT stage includes adjusting an IFFT length to a RS duration and multiplexing the one or more RSs at a post-IFFT stage; the one or more RSs are TDM within a symbol with modulated RS samples at time-samples corresponding to a CP of an associated signal at a pre-CP insertion stage.

Additionally, the UE 1400 may be configured to support any one or combination of where the at least one processor is configured to cause the UE to generate the one or more RSs using a digital quantization step from one or more supported digital quantization steps of the UE; the at least one processor is configured to cause the UE to generate the one or more RSs using digital quantization at one or more of: after an IFFT stage and prior to CP insertion; after the IFFT stage and after CP insertion; after an upsampling and filtering stage; or after a RS generated in time domain (e.g., a time-domain signal of an RS generated according to a known waveform (e.g., a CP-OFDM or DFT-s-OFDM)); the at least one processor is configured to cause the UE to adjust one or more parameters of the one or more RSs to be within a discrete space (e.g., a discrete set of values associated with a DAC) prior to transmission of the one or more RSs; the at least one processor is configured to cause the UE to transmit an indication of the adjusted one or more parameters of the one or more RSs.

The UE 1400 may be configured to or operable to support a means for receiving first capability information including one or more low-resolution transmit behaviors of a radio node, and one or more RSs; receiving third configuration information including an indication of one or more measurement quantities to be computed based at least in part on the RSs; and transmitting a measurement report generated based at least in part on the third configuration information, the measurement report including the one or more measurement quantities.

Additionally, the UE 1400 may be configured to support any one or combination of receiving an indication of an association between the one or more RSs and one or more other transmissions (e.g., transmissions of a physical data/control channel and/or other RSs); the third configuration information includes an indication that the measurement report is to be generated using one or more RSs that meet a distortion condition (e.g., indicated with one or more of a low distortion condition, a high Tx SNR condition, or a low EVM condition).

Additionally, or alternatively, the UE 1400 may support at least one memory (e.g., the memory 1404) and at least one processor (e.g., the processor 1402) coupled with the at least one memory and configured to cause the UE to receive first capability information including one or more low-resolution transmit behaviors of a radio node, and one or more RSs; receive third configuration information including an indication of one or more measurement quantities to be computed based at least in part on the RSs; and transmit a measurement report generated based at least in part on the third configuration information, the measurement report including the one or more measurement quantities.

Additionally, the UE 1400 may be configured to support any one or combination of where the at least one processor is configured to cause the UE to receive an indication of an association between the one or more RSs and one or more other transmissions (e.g., transmissions of a physical data/control channel and/or other RSs); the third configuration information includes an indication that the measurement report is to be generated using one or more RSs that meet a distortion condition (e.g., indicated with one or more of a low distortion condition, a high Tx SNR condition, or a low EVM condition).

The controller 1406 may manage input and output signals for the UE 1400. The controller 1406 may also manage peripherals not integrated into the UE 1400. In some implementations, the controller 1406 may utilize an operating system such as iOS®, ANDROID®, WINDOWS®, or other operating systems. In some implementations, the controller 1406 may be implemented as part of the processor 1402.

In some implementations, the UE 1400 may include at least one transceiver 1408. In some other implementations, the UE 1400 may have more than one transceiver 1408. The transceiver 1408 may represent a wireless transceiver. The transceiver 1408 may include one or more receiver chains 1410, one or more transmitter chains 1412, or a combination thereof.

A receiver chain 1410 may be configured to receive signals (e.g., control information, data, packets) over a wireless medium. For example, the receiver chain 1410 may include one or more antennas to receive a signal over the air or wireless medium. The receiver chain 1410 may include at least one amplifier (e.g., a low-noise amplifier (LNA)) configured to amplify the received signal. The receiver chain 1410 may include at least one demodulator configured to demodulate the receive signal and obtain the transmitted data by reversing the modulation technique applied during transmission of the signal. The receiver chain 1410 may include at least one decoder for decoding the demodulated signal to receive the transmitted data.

A transmitter chain 1412 may be configured to generate and transmit signals (e.g., control information, data, packets). The transmitter chain 1412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1412 may also include at least one power amplifier configured to amplify the modulated signal to an appropriate power level suitable for transmission over the wireless medium. The transmitter chain 1412 may also include one or more antennas for transmitting the amplified signal into the air or wireless medium.

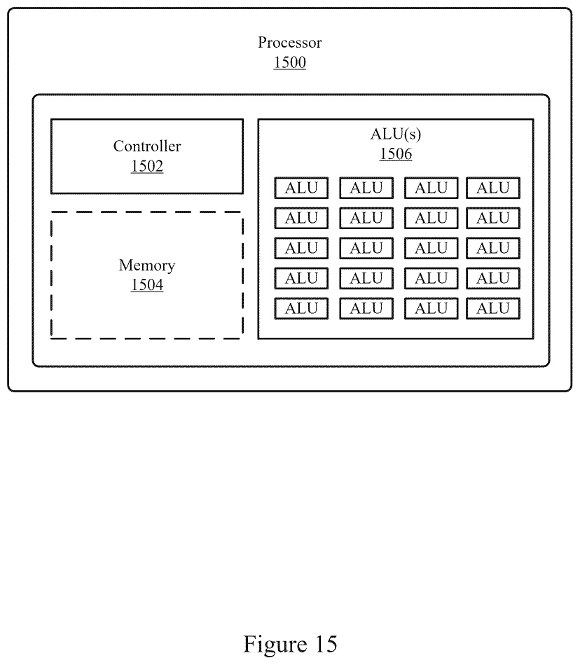

FIG. 15 illustrates an example of a processor 1500 in accordance with aspects of the present disclosure. The processor 1500 may be an example of a processor configured to perform various operations in accordance with examples as described herein. The processor 1500 may include a controller 1502 configured to perform various operations in accordance with examples as described herein. The processor 1500 may optionally include at least one memory 1504, which may be, for example, an L1/L2/L3 cache. Additionally, or alternatively, the processor 1500 may optionally include one or more arithmetic-logic units (ALUs) 1506. One or more of these components may be in electronic communication or otherwise coupled (e.g., operatively, communicatively, functionally, electronically, electrically) via one or more interfaces (e.g., buses).

The processor 1500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1502 may be configured to manage and coordinate various operations (e.g., signaling, receiving, obtaining, retrieving, transmitting, outputting, forwarding, storing, determining, identifying, accessing, writing, reading) of the processor 1500 to cause the processor 1500 to support various operations in accordance with examples as described herein. For example, the controller 1502 may operate as a control unit of the processor 1500, generating control signals that manage the operation of various components of the processor 1500. These control signals include enabling or disabling functional units, selecting data paths, initiating memory access, and coordinating timing of operations.

The controller 1502 may be configured to fetch (e.g., obtain, retrieve, receive) instructions from the memory 1504 and determine subsequent instruction(s) to be executed to cause the processor 1500 to support various operations in accordance with examples as described herein. The controller 1502 may be configured to track memory addresses of instructions associated with the memory 1504. The controller 1502 may be configured to decode instructions to determine the operation to be performed and the operands involved. For example, the controller 1502 may be configured to interpret the instruction and determine control signals to be output to other components of the processor 1500 to cause the processor 1500 to support various operations in accordance with examples as described herein. Additionally, or alternatively, the controller 1502 may be configured to manage flow of data within the processor 1500. The controller 1502 may be configured to control transfer of data between registers, ALUs 1506, and other functional units of the processor 1500.

The memory 1504 may include one or more caches (e.g., memory local to or included in the processor 1500 or other memory, such as RAM, ROM, DRAM, SDRAM, SRAM, MRAM, flash memory, etc. In some implementations, the memory 1504 may reside within or on a processor chipset (e.g., local to the processor 1500). In some other implementations, the memory 1504 may reside external to the processor chipset (e.g., remote to the processor 1500).

The memory 1504 may store computer-readable, computer-executable code including instructions that, when executed by the processor 1500, cause the processor 1500 to perform various functions described herein. The code may be stored in a non-transitory computer-readable medium such as system memory or another type of memory. The controller 1502 and/or the processor 1500 may be configured to execute computer-readable instructions stored in the memory 1504 to cause the processor 1500 to perform various functions. For example, the processor 1500 and/or the controller 1502 may be coupled with or to the memory 1504, the processor 1500, and the controller 1502, and may be configured to perform various functions described herein. In some examples, the processor 1500 may include multiple processors and the memory 1504 may include multiple memories. One or more of the multiple processors may be coupled with one or more of the multiple memories, which may, individually or collectively, be configured to perform various functions herein.

The one or more ALUs 1506 may be configured to support various operations in accordance with examples as described herein. In some implementations, the one or more ALUs 1506 may reside within or on a processor chipset (e.g., the processor 1500). In some other implementations, the one or more ALUs 1506 may reside external to the processor chipset (e.g., the processor 1500). One or more ALUs 1506 may perform one or more computations such as addition, subtraction, multiplication, and division on data. For example, one or more ALUs 1506 may receive input operands and an operation code, which determines an operation to be executed. One or more ALUs 1506 may be configured with a variety of logical and arithmetic circuits, including adders, subtractors, shifters, and logic gates, to process and manipulate the data according to the operation. Additionally, or alternatively, the one or more ALUs 1506 may support logical operations such as AND, OR, exclusive-OR (XOR), not-OR (NOR), and not-AND (NAND), enabling the one or more ALUs 1506 to handle conditional operations, comparisons, and bitwise operations.

The processor 1500 may support wireless communication in accordance with examples as disclosed herein. The processor 1500 may be configured to or operable to support at least one controller (e.g., the controller 1502) coupled with at least one memory (e.g., the memory 1504) and configured to cause the processor to transmit first capability information including one or more low-resolution transmit behaviors of a radio node; receive second configuration information for transmission of a RS; and transmit, based at least in part on the second configuration information, one or more RSs.

Additionally, the processor 1500 may be configured to or operable to support any one or combination of where the one or more low-resolution transmit behaviors of the radio node are associated with a low resolution DAC of the radio node, and the RS includes a sequence of time-domain complex values; the first capability information includes capability information for the radio node, the capability information including one or more of: a discrete set as a subset of one or more supported steps of one or more DACs of the radio node; a first value equal to or smaller than a number of quantization states supported by the one or more DACs of the radio node; a second value equal to or smaller than a number of quantization bits supported by the one or more DACs of the radio node; or at least one supported sampling time of the one or more DACs of the radio node; the second configuration information includes one or more of: a sequence of complex values defined in time-domain as an output of a digital baseband processor; a defined sequence of complex values defined in the time-domain as input of one or more DACs of the radio node; one or more of a sampling time or a sampling rate associated with the defined sequence of complex values; a scaling value applied on the defined sequence of complex values; a phase rotation applied on the define complex sequence of complex values; a reference to one or more previous RSs; or different RS definitions for multiple different transmission directions; the at least one controller is configured to cause the processor to autonomously determine one or more RS parameters.

Additionally, the processor 1500 may be configured to or operable to support any one or combination of where the at least one controller is configured to cause the processor to one or more of: TDM the one or more RSs with a second transmission; assign the one or more RSs to one or more indicated symbols; or assign the one or more RSs to one or more dedicated symbols within a slot, the one or more dedicated symbols including symbol features dedicated for RSs; a slot or a subframe that includes one or more RS symbols includes differing parameters or characteristics than a slot or a subframe that does not include one or more RS symbols; one or more of: one or more of RS symbol parameters, RS symbol slot format, or RS subframe format are indicated via reference to a codebook; or a codebook for RS is associated with one or more of a transmission direction or a low resolution feature of the radio node; one or more of: the one or more RSs are TDM as part of a defined symbol; or the one or more RSs are TDM within a shared symbol with a second transmission; one or more of: transmission of the one or more RSs at a symbol including an IFFT stage includes shaping dedicated REs for time-domain shaping; or transmission of the one or more RSs at a symbol including an IFFT stage includes adjusting an IFFT length to a RS duration and multiplexing the one or more RSs at a post-IFFT stage.

Additionally, the processor 1500 may be configured to or operable to support any one or combination of where the one or more RSs are TDM within a symbol with modulated RS samples at time-samples corresponding to a CP of an associated signal at a pre-CP insertion stage; the at least one controller is configured to cause the processor to generate the one or more RSs using a digital quantization step from one or more supported digital quantization steps of the radio node; the at least one controller is configured to cause the processor to generate the one or more RSs using digital quantization at one or more of: after an IFFT stage and prior to CP insertion; after the IFFT stage and after CP insertion; after an upsampling and filtering stage; or after a RS generated in time domain (e.g., a time-domain signal of an RS generated according to a known waveform (e.g., a CP-OFDM or DFT-s-OFDM)); the at least one controller is configured to cause the processor to adjust one or more parameters of the one or more RSs to be within a discrete space (e.g., a discrete set of values associated with a DAC) prior to transmission of the one or more RSs; the at least one controller is configured to cause the processor to transmit an indication of the adjusted one or more parameters of the one or more RSs.

The processor 1500 may support wireless communication in accordance with examples as disclosed herein. The processor 1500 may be configured to or operable to support at least one controller (e.g., the controller 1502) coupled with at least one memory (e.g., the memory 1504) and configured to cause the processor to receive first capability information including one or more low-resolution transmit behaviors of a radio node, and one or more RSs; receive third configuration information including an indication of one or more measurement quantities to be computed based at least in part on the RSs; and transmit a measurement report generated based at least in part on the third configuration information, the measurement report including the one or more measurement quantities.

Additionally, the processor 1500 may be configured to or operable to support any one or combination of where the at least one controller is configured to cause the processor to receive an indication of an association between the one or more RSs and one or more other transmissions (e.g., transmissions of a physical data/control channel and/or other RSs); the third configuration information includes an indication that the measurement report is to be generated using one or more RSs that meet a distortion condition (e.g., indicated with one or more of a low distortion condition, a high Tx SNR condition, or a low EVM condition).

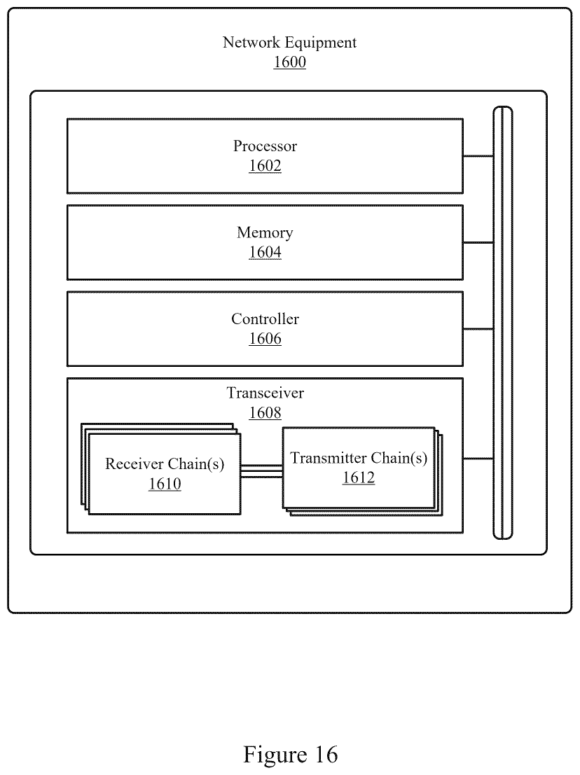

FIG. 16 illustrates an example of a NE 1600 in accordance with aspects of the present disclosure. The NE 1600 may include a processor 1602, a memory 1604, a controller 1606, and a transceiver 1608. The processor 1602, the memory 1604, the controller 1606, or the transceiver 1608, or various combinations thereof or various components thereof may be examples of means for performing various aspects of the present disclosure as described herein. These components may be coupled (e.g., operatively, communicatively, functionally, electronically, electrically) via one or more interfaces.

The processor 1602, the memory 1604, the controller 1606, or the transceiver 1608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1602 may include an intelligent hardware device (e.g., a general-purpose processor, a DSP, a CPU, an ASIC, an FPGA, or any combination thereof). In some implementations, the processor 1602 may be configured to operate the memory 1604. In some other implementations, the memory 1604 may be integrated into the processor 1602. The processor 1602 may be configured to execute computer-readable instructions stored in the memory 1604 to cause the NE 1600 to perform various functions of the present disclosure.

The memory 1604 may include volatile or non-volatile memory. The memory 1604 may store computer-readable, computer-executable code including instructions when executed by the processor 1602 cause the NE 1600 to perform various functions described herein. The code may be stored in a non-transitory computer-readable medium such as the memory 1604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1602 and the memory 1604 coupled with the processor 1602 may be configured to cause the NE 1600 to perform one or more of the functions described herein (e.g., executing, by the processor 1602, instructions stored in the memory 1604). For example, the processor 1602 may support wireless communication at the NE 1600 in accordance with examples as disclosed herein.

The NE 1600 may be configured to or operable to support a means for transmitting first capability information including one or more low-resolution transmit behaviors of the NE; receiving second configuration information for transmission of a RS; and transmitting, based at least in part on the second configuration information, one or more RSs.

Additionally, the NE 1600 may be configured to or operable to support any one or combination of where the one or more low-resolution transmit behaviors of the NE are associated with a low resolution DAC of the NE, and the RS includes a sequence of time-domain complex values; the first capability information includes capability information for the NE, the capability information including one or more of: a discrete set as a subset of one or more supported steps of one or more DACs of the NE; a first value equal to or smaller than a number of quantization states supported by the one or more DACs of the NE; a second value equal to or smaller than a number of quantization bits supported by the one or more DACs of the NE; or at least one supported sampling time of the one or more DACs of the NE; the second configuration information includes one or more of: a sequence of complex values defined in time-domain as an output of a digital baseband processor; a defined sequence of complex values defined in the time-domain as input of one or more DACs of the NE; one or more of a sampling time or a sampling rate associated with the defined sequence of complex values; a scaling value applied on the defined sequence of complex values; a phase rotation applied on the define complex sequence of complex values; a reference to one or more previous RSs; or different RS definitions for multiple different transmission directions; autonomously determining one or more RS parameters.

Additionally, the NE 1600 may be configured to or operable to support any one or combination of where one or more of: time division multiplexing (TDM) the one or more RSs with a second transmission; assigning the one or more RSs to one or more indicated symbols; or assigning the one or more RSs to one or more dedicated symbols within a slot, the one or more dedicated symbols including symbol features dedicated for RSs; a slot or a subframe that includes one or more RS symbols includes differing parameters or characteristics than a slot or a subframe that does not include one or more RS symbols; one or more of: one or more of RS symbol parameters, RS symbol slot format, or RS subframe format are indicated via reference to a codebook; or a codebook for RS is associated with one or more of a transmission direction or a low resolution feature of the NE; one or more of: the one or more RSs are TDM as part of a defined symbol; or the one or more RSs are TDM within a shared symbol with a second transmission; one or more of: transmission of the one or more RSs at a symbol including an IFFT stage includes shaping dedicated REs for time-domain shaping; or transmission of the one or more RSs at a symbol including an IFFT stage includes adjusting an IFFT length to a RS duration and multiplexing the one or more RSs at a post-IFFT stage.

Additionally, the NE 1600 may be configured to or operable to support any one or combination of where the one or more RSs are TDM within a symbol with modulated RS samples at time-samples corresponding to a CP of an associated signal at a pre-CP insertion stage; generating the one or more RSs using a digital quantization step from one or more supported digital quantization steps of the NE; generating the one or more RSs using digital quantization at one or more of: after an IFFT stage and prior to CP insertion; after the IFFT stage and after CP insertion; after an upsampling and filtering stage; or after a RS generated in time domain (e.g., a time-domain signal of an RS generated according to a known waveform (e.g., a CP-OFDM or DFT-s-OFDM)); adjusting one or more parameters of the one or more RSs to be within a discrete space (e.g., a discrete set of values associated with a DAC) prior to transmission of the one or more RSs; transmitting an indication of the adjusted one or more parameters of the one or more RSs.

Additionally, or alternatively, the NE 1600 may support at least one memory (e.g., the memory 1604) and at least one processor (e.g., the processor 1602) coupled with the at least one memory and configured to cause the NE to transmit first capability information including one or more low-resolution transmit behaviors of the NE; receive second configuration information for transmission of a RS; and transmit, based at least in part on the second configuration information, one or more RSs.

Additionally, the NE 1600 may be configured to support any one or combination of where the one or more low-resolution transmit behaviors of the NE are associated with a low resolution DAC of the NE, and the RS includes a sequence of time-domain complex values; the first capability information includes capability information for the NE, the capability information including one or more of: a discrete set as a subset of one or more supported steps of one or more DACs of the NE; a first value equal to or smaller than a number of quantization states supported by the one or more DACs of the NE; a second value equal to or smaller than a number of quantization bits supported by the one or more DACs of the NE; or at least one supported sampling time of the one or more DACs of the NE; the second configuration information includes one or more of: a sequence of complex values defined in time-domain as an output of a digital baseband processor; a defined sequence of complex values defined in the time-domain as input of one or more DACs of the NE; one or more of a sampling time or a sampling rate associated with the defined sequence of complex values; a scaling value applied on the defined sequence of complex values; a phase rotation applied on the define complex sequence of complex values; a reference to one or more previous RSs; or different RS definitions for multiple different transmission directions; the at least one processor is configured to cause the NE to autonomously determine one or more RS parameters.

Additionally, the NE 1600 may be configured to support any one or combination of where the at least one processor is configured to cause the NE to one or more of: TDM the one or more RSs with a second transmission; assign the one or more RSs to one or more indicated symbols; or assign the one or more RSs to one or more dedicated symbols within a slot, the one or more dedicated symbols including symbol features dedicated for RSs; a slot or a subframe that includes one or more RS symbols includes differing parameters or characteristics than a slot or a subframe that does not include one or more RS symbols; one or more of: one or more of RS symbol parameters, RS symbol slot format, or RS subframe format are indicated via reference to a codebook; or a codebook for RS is associated with one or more of a transmission direction or a low resolution feature of the NE; one or more of: the one or more RSs are TDM as part of a defined symbol; or the one or more RSs are TDM within a shared symbol with a second transmission; one or more of: transmission of the one or more RSs at a symbol including an IFFT stage includes shaping dedicated REs for time-domain shaping; or transmission of the one or more RSs at a symbol including an IFFT stage includes adjusting an IFFT length to a RS duration and multiplexing the one or more RSs at a post-IFFT stage.

Additionally, the NE 1600 may be configured to support any one or combination of where the one or more RSs are TDM within a symbol with modulated RS samples at time-samples corresponding to a CP of an associated signal at a pre-CP insertion stage; the at least one processor is configured to cause the NE to generate the one or more RSs using a digital quantization step from one or more supported digital quantization steps of the NE; the at least one processor is configured to cause the NE to generate the one or more RSs using digital quantization at one or more of: after an IFFT stage and prior to CP insertion; after the IFFT stage and after CP insertion; after an upsampling and filtering stage; or after a RS generated in time domain (e.g., a time-domain signal of an RS generated according to a known waveform (e.g., a CP-OFDM or DFT-s-OFDM)); the at least one processor is configured to cause the NE to adjust one or more parameters of the one or more RSs to be within a discrete space (e.g., a discrete set of values associated with a DAC) prior to transmission of the one or more RSs; the at least one processor is configured to cause the NE to transmit an indication of the adjusted one or more parameters of the one or more RSs.

The NE 1600 may be configured to or operable to support a means for receiving first capability information including one or more low-resolution transmit behaviors of a radio node, and one or more RSs; receiving third configuration information including an indication of one or more measurement quantities to be computed based at least in part on the RSs; and transmitting a measurement report generated based at least in part on the third configuration information, the measurement report including the one or more measurement quantities.

Additionally, the NE 1600 may be configured to or operable to support any one or combination of receiving an indication of an association between the one or more RSs and one or more other transmissions (e.g., transmissions of a physical data/control channel and/or other RSs); the third configuration information includes an indication that the measurement report is to be generated using one or more RSs that meet a distortion condition (e.g., indicated with one or more of a low distortion condition, a high Tx SNR condition, or a low EVM condition).

Additionally, or alternatively, the NE 1600 may support at least one memory (e.g., the memory 1604) and at least one processor (e.g., the processor 1602) coupled with the at least one memory and configured to cause the NE to receive first capability information including one or more low-resolution transmit behaviors of a radio node, and one or more RSs; receive third configuration information including an indication of one or more measurement quantities to be computed based at least in part on the RSs; and transmit a measurement report generated based at least in part on the third configuration information, the measurement report including the one or more measurement quantities.

Additionally, the NE 1600 may be configured to support any one or combination of where the at least one processor is configured to cause the NE to receive an indication of an association between the one or more RSs and one or more other transmissions (e.g., transmissions of a physical data/control channel and/or other RSs); the third configuration information includes an indication that the measurement report is to be generated using one or more RSs that meet a distortion condition (e.g., indicated with one or more of a low distortion condition, a high Tx SNR condition, or a low EVM condition).

The controller 1606 may manage input and output signals for the NE 1600. The controller 1606 may also manage peripherals not integrated into the NE 1600. In some implementations, the controller 1606 may utilize an operating system such as iOS®, ANDROID®, WINDOWS®, or other operating systems. In some implementations, the controller 1606 may be implemented as part of the processor 1602.

In some implementations, the NE 1600 may include at least one transceiver 1608. In some other implementations, the NE 1600 may have more than one transceiver 1608. The transceiver 1608 may represent a wireless transceiver. The transceiver 1608 may include one or more receiver chains 1610, one or more transmitter chains 1612, or a combination thereof.

A receiver chain 1610 may be configured to receive signals (e.g., control information, data, packets) over a wireless medium. For example, the receiver chain 1610 may include one or more antennas to receive a signal over the air or wireless medium. The receiver chain 1610 may include at least one amplifier (e.g., a low-noise amplifier (LNA)) configured to amplify the received signal. The receiver chain 1610 may include at least one demodulator configured to demodulate the receive signal and obtain the transmitted data by reversing the modulation technique applied during transmission of the signal. The receiver chain 1610 may include at least one decoder for decoding the demodulated signal to receive the transmitted data.

A transmitter chain 1612 may be configured to generate and transmit signals (e.g., control information, data, packets). The transmitter chain 1612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1612 may also include at least one power amplifier configured to amplify the modulated signal to an appropriate power level suitable for transmission over the wireless medium. The transmitter chain 1612 may also include one or more antennas for transmitting the amplified signal into the air or wireless medium.

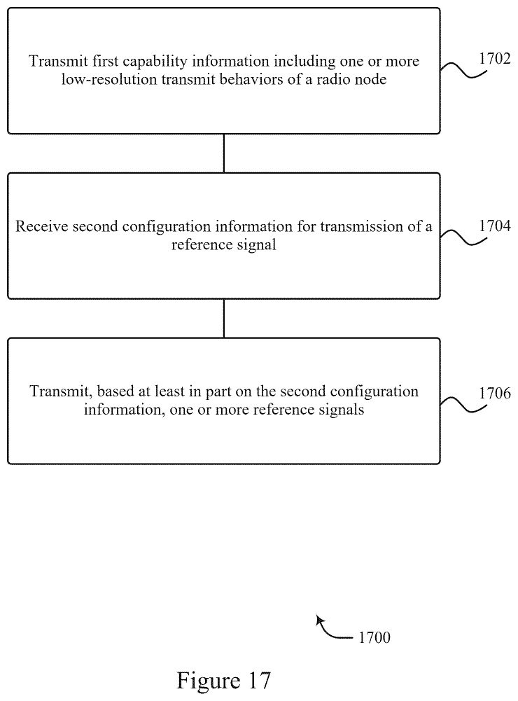

FIG. 17 illustrates a flowchart of a method 1700 in accordance with aspects of the present disclosure. The operations of the method may be implemented by a UE and/or an NE as described herein. In some implementations, the UE and/or NE may execute a set of instructions to control the function elements of the UE and/or NE to perform the described functions. It should be noted that the method described herein describes a possible implementation, and that the operations and the steps may be rearranged or otherwise modified and that other implementations are possible.

At 1702, the method may include transmitting first capability information including one or more low-resolution transmit behaviors of a radio node. The operations of 1702 may be performed in accordance with examples as described herein. In some implementations, aspects of the operations of 1702 may be performed by a UE as described with reference to FIG. 14 and/or an NE as described with reference to 16.

At 1704, the method may include receiving second configuration information for transmission of a RS. The operations of 1704 may be performed in accordance with examples as described herein. In some implementations, aspects of the operations of 1704 may be performed by a UE as described with reference to FIG. 14 and/or an NE as described with reference to 16.

At 1706, the method may include transmitting, based at least in part on the second configuration information, one or more RSs. The operations of 1706 may be performed in accordance with examples as described herein. In some implementations, aspects of the operations of 1706 may be performed a UE as described with reference to FIG. 14 and/or an NE as described with reference to 16.

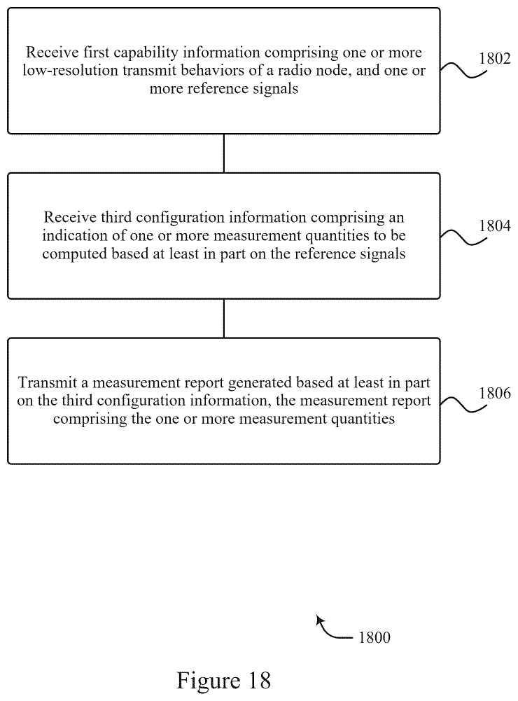

FIG. 18 illustrates a flowchart of a method 1800 in accordance with aspects of the present disclosure. The operations of the method may be implemented by a UE and/or an NE as described herein. In some implementations, the UE and/or NE may execute a set of instructions to control the function elements of the UE and/or NE to perform the described functions. It should be noted that the method described herein describes a possible implementation, and that the operations and the steps may be rearranged or otherwise modified and that other implementations are possible.

At 1802, the method may include receiving first capability information comprising one or more low-resolution transmit behaviors of a radio node, and one or more RSs. The operations of 1802 may be performed in accordance with examples as described herein. In some implementations, aspects of the operations of 1802 may be performed by a UE as described with reference to FIG. 14 and/or an NE as described with reference to 16.

At 1804, the method may include receiving third configuration information comprising an indication of one or more measurement quantities to be computed based at least in part on the RSs. The operations of 1804 may be performed in accordance with examples as described herein. In some implementations, aspects of the operations of 1804 may be performed by a UE as described with reference to FIG. 14 and/or an NE as described with reference to 16.

At 1806, the method may include transmitting a measurement report generated based at least in part on the third configuration information, the measurement report comprising the one or more measurement quantities. The operations of 1806 may be performed in accordance with examples as described herein. In some implementations, aspects of the operations of 1806 may be performed a UE as described with reference to FIG. 14 and/or an NE as described with reference to 16.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first radio node for wireless communication, comprising:
at least one memory; and
at least one processor coupled with the at least one memory and configured to cause the first radio node to:
transmit first capability information comprising one or more low-resolution transmit behaviors of the first radio node;
receive second configuration information for transmission of a reference signal; and
transmit, based at least in part on the second configuration information, one or more reference signals.

2. The first radio node of claim 1, wherein the one or more low-resolution transmit behaviors of the first radio node are associated with a low resolution digital-to-analog converter (DAC) of the first radio node, and the reference signal comprises a sequence of time-domain complex values.

3. The first radio node of claim 1, wherein the first capability information comprises capability information for the first radio node, the capability information comprising one or more of:
a discrete set as a subset of one or more supported steps of one or more digital-to-analog converters (DACs) of the first radio node;
a first value equal to or smaller than a number of quantization states supported by the one or more DACs of the first radio node;
a second value equal to or smaller than a number of quantization bits supported by the one or more DACs of the first radio node; or
at least one supported sampling time of the one or more DACs of the first radio node.

4. The first radio node of claim 1, wherein the second configuration information comprises one or more of:
a sequence of complex values defined in time-domain as an output of a digital baseband processor;
a defined sequence of complex values defined in the time-domain as input of one or more digital-to-analog converters (DACs) of the first radio node;
one or more of a sampling time or a sampling rate associated with the defined sequence of complex values;
a scaling value applied on the defined sequence of complex values;
a phase rotation applied on the define complex sequence of complex values;
a reference to one or more previous reference signals; or
different reference signal definitions for multiple different transmission directions.

5. The first radio node of claim 1, wherein the at least one processor is configured to cause the first radio node to autonomously determine one or more reference signal parameters.

6. The first radio node of claim 1, wherein the at least one processor is configured to cause the first radio node to one or more of:
time division multiplex (TDM) the one or more reference signals with a second transmission;
assign the one or more reference signals to one or more indicated symbols; or
assign the one or more reference signals to one or more dedicated symbols within a slot, the one or more dedicated symbols comprising symbol features dedicated for reference signals.

7. The first radio node of claim 1, wherein a slot or a subframe that includes one or more reference signal symbols comprises differing parameters or characteristics than a slot or a subframe that does not include one or more reference signal symbols.

8. The first radio node of claim 1, wherein one or more of:
one or more of reference signal symbol parameters, reference signal symbol slot format, or reference signal subframe format are indicated via reference to a codebook; or
a codebook for reference signal is associated with one or more of a transmission direction or a low resolution feature of the first radio node.

9. The first radio node of claim 1, wherein one or more of:
the one or more reference signals are time division multiplexed (TDM) as part of a defined symbol; or
the one or more reference signals are TDM within a shared symbol with a second transmission.

10. The first radio node of claim 1, wherein one or more of:
transmission of the one or more reference signals at a symbol including an inverse Fast Fourier Transform (IFFT) stage includes shaping dedicated REs for time-domain shaping; or
transmission of the one or more reference signals at a symbol including an IFFT stage includes adjusting an IFFT length to a reference signal duration and multiplexing the one or more reference signals at a post-IFFT stage.

11. The first radio node of claim 1, wherein the one or more reference signals are time division multiplexed (TDM) within a symbol with modulated reference signal samples at time-samples corresponding to a cyclic prefix (CP) of an associated signal at a pre-CP insertion stage.

12. The first radio node of claim 1, wherein the at least one processor is configured to cause the first radio node to generate the one or more reference signals using a digital quantization step from one or more supported digital quantization steps of the first radio node.

13. The first radio node of claim 1, wherein the at least one processor is configured to cause the first radio node to generate the one or more reference signals using digital quantization at one or more of:
after an inverse Fast Fourier Transform (IFFT) stage and prior to cyclic prefix (CP) insertion;
after the IFFT stage and after CP insertion;
after an upsampling and filtering stage; or
after a reference signal generated in time domain.

14. The first radio node of claim 1, wherein the at least one processor is configured to cause the first radio node to adjust one or more parameters of the one or more reference signals to be within a discrete space prior to transmission of the one or more reference signals.

15. The first radio node of claim 14, wherein the at least one processor is configured to cause the first radio node to transmit an indication of the adjusted one or more parameters of the one or more reference signals.

16. A second radio node for wireless communication, comprising:
at least one memory; and
at least one processor coupled with the at least one memory and configured to cause the second radio node to:
receive first capability information comprising one or more low-resolution transmit behaviors of a first radio node, and one or more reference signals;
receive third configuration information comprising an indication of one or more measurement quantities to be computed based at least in part on the reference signals; and
transmit a measurement report generated based at least in part on the third configuration information, the measurement report comprising the one or more measurement quantities.

17. The second radio node of claim 16, wherein the at least one processor is configured to cause the second radio node to receive an indication of an association between the one or more reference signals and one or more other transmissions.

18. The second radio node of claim 16, wherein the third configuration information comprises an indication that the measurement report is to be generated using one or more reference signals that meet a distortion condition.

19. A processor for wireless communication, comprising:
at least one controller coupled with at least one memory and configured to cause the processor to:
transmit first capability information comprising one or more low-resolution transmit behaviors of a radio node;
receive second configuration information for transmission of a reference signal, wherein the reference signal comprises a sequence of time-domain complex values; and
transmit, based at least in part on the second configuration information, one or more reference signals.

20. A processor for wireless communication, comprising:
at least one controller coupled with at least one memory and configured to cause the processor to:
receive first capability information comprising one or more low-resolution transmit behaviors of a radio node, and one or more reference signals;
receive third configuration information comprising an indication of one or more measurement quantities to be computed based at least in part on the reference signals; and
transmit a measurement report generated based at least in part on the third configuration information, the measurement report comprising the one or more measurement quantities.
